(19) United States
(12) Patent Application Publication
(10) Pub. No.: US 2026/0164150 A1
(43) Pub. Date: Jun. 11, 2026

(54) MULTI-RAIL WAVELENGTH ROUTING OPTICAL ARCHITECTURE

(71) Applicant: Molex, LLC, Lisle, IL (US)

(72) Inventors: Mark E. Boduch, Woodstock, IL (US); Lifu Gong, Fremont, CA (US)

(73) Assignee: Molex, LLC, Lisle, IL (US)

(21) Appl. No.: 19/416,840

(22) Filed: Dec. 11, 2025

Related U.S. Application Data
(60) Provisional application No. 63/730,466, filed on Dec. 11, 2024.

(51) Int. Cl. H04Q 11/00; H04J 14/02

(52) U.S. Cl. CPC H04Q 11/0005; H04J 14/0212; H04Q 11/0062; H04Q 2011/0016

(57) ABSTRACT

Apparatus for routing optical wavelengths over one or more optical fibers from a first physical site to a second physical site. In some embodiments of the present disclosure, an optical apparatus comprises a plurality of first optical interfaces; a plurality of second optical interfaces; a plurality of optical wavelength multiplexers operable to multiplex a first set of wavelengths from a plurality of optical transceivers; a plurality of optical wavelength demultiplexers operable to demultiplex a second set of wavelengths to the plurality of optical transceivers; and a singular wavelength-switching device operable to individually switch wavelengths of the first set of wavelengths from the plurality of optical wavelength multiplexers to the plurality of first optical interfaces and to the plurality of optical wavelength demultiplexers, and operable to individually switch wavelengths of the second set of wavelengths from the plurality of second optical interfaces to the plurality of optical wavelength demultiplexers.

### FIELD OF THE DISCLOSURE

This disclosure is directed to apparatus for routing optical wavelengths over one or more optical fibers from a first physical site to a second physical site. The first physical site could be, for example, a first data center, and the second physical site could be, for example, a second data center.

### BACKGROUND

The advent of Artificial Intelligence (AI) has generated the need to send large amounts of information between data centers using optical fiber as the transmission media. In the past, increases in information transport have been accomplished by both increasing the number of optical wavelengths on a given optical fiber, and increasing the data rate of each wavelength transported on the given optical fiber.

The first commercial Dense Wavelength Division Multiplexing (DWDM) system carried sixteen 2.5 Gbps wavelengths over a single fiber. Later, systems were available that could transport thirty-two, and then forty, and then forty-four, and then eighty-eight 10 Gbps wavelengths over a single optical fiber. Later still, ninety-six 100-Gbps wavelengths were transported within the optical C-band over a single fiber, using 50 GHz channel spacing, and coherent polarization-multiplexed differential quadrature phase shift keying (CP-DQPSK) modulation. This resulted in an aggregate bit rate over a single fiber of 9.6 Tbps (96×100 Gbps) within the 4.8 THz optical (extended) C-band (96×50 GHz). More recently, as the bit rate over a single wavelength has increased, larger channel spacing has been required for each wavelength, so the number of wavelengths over a single fiber within the optical C-band has decreased (even though the total aggregated bit rate has increased). For instance, sixty-four 400 Gbps wavelengths have been transported within the C-band over a single fiber using 75 GHz channel spacing (64×75 GHz=4.8 THz), resulting in an aggregate bit rate over a single fiber of 25.6 Tbps (64×400 Gbps). More recently, thirty-two 800 Gbps wavelengths have been transported within the C-band over a single fiber, using 150 GHz channel spacing, resulting in an aggregate bit rate over a single fiber of 25.6 Tbps (32×800 Gbps). A 300 GHz channel spacing has been suggested to support 1.6 Tbps wavelengths, with the ability to transport sixteen such wavelengths over the optical C-band. The aggregate bit rate over a single fiber would remain at 25.6 Tbps (16×1.6 Tbps). With each recent evolution of optical transceiver technology, the aggregate capacity within the C-band over a single fiber has been remaining constant (although the number of optical transceivers required to fully populate the C-band continues to decrease). To address this issue, some manufacturers have developed equipment which can transport wavelengths over a single fiber using both the optical C-band and the optical L-band. However, the wavelengths carried over the L-band suffer from reduced performance and often results in an increase in system complexity. Another method of transporting higher aggregate bit rates between two physical sites is using multiple fibers. For instance, using four optical fibers and sixty-four 1.6 Tbps wavelengths over the C-band, an aggregate bit rate of 102.4 Tbps (64×1.6Tbps) is achieved. However, every time an additional fiber is used to transport additional capacity, an additional set of equipment (optical multiplexers, optical demultiplexers, optical amplifiers, electrical shelves, electrical processors, etc.) is required, driving up the monetary cost, physical space, and electrical power requirements of the deployment. Consequently, there is a need in the art for methods of decreasing the space, power, and cost of this equipment. FIG. 1 depicts an optical transport network 100 having a first physical site (102) and a second physical site (104) in accordance with the prior art. Each site 102, 104 contains a single optical line termination (OLT) card 106, 108 and a plurality of optical transceivers 110₁ to 110_{N}, 111₁ to 111_{N} (also referred to as simply “transceivers”). The optical transceivers 110₁ to 110_{N}, 111₁ to 111_{N} generate and terminate optical wavelengths 112₁ to 112_{N}, 114₁ to 114_{N}, while the optical line termination card multiplexes and demultiplexes the wavelengths into and out of a single DWDM signal that is transported over a single fibers 116, 118 in each direction between the two sites 102, 104 from Line TX optical interfaces 120, 122 to Line RX optical interfaces 124, 126. For two sites separated by nearly any amount of reasonable distance, optical amplifiers are required to first amplify the DWDM signal as it exits a given site, and to again amplify the DWDM signal as it enters a given site. These amplifiers are located on the optical line termination cards 106, 108 (not shown in FIG. 1). FIG. 2 depicts the optical line termination card 106 or 108 in greater detail in accordance with the prior art. The optical line termination card 106 or 108 uses an (N+1)×2 Wavelength Selective Switch (WSS) 202 to multiplex the N wavelengths from the N number of optical transceivers 110₁ to 110_{N} or 111₁ to 111_{N} and uses a 2×N Wavelength Selective Switch 204 to demultiplex N wavelengths to the N number of optical transceivers 110₁ to 110_{N} or 111₁ to 111_{N}. The (N+1)×2 WSS 202 can route any wavelength from the optical transceivers 110₁ to 110_{N} or 111₁ to 111_{N} to either a first output 206 of the WSS 202 directed to a Line TX optical interface 120 or 122, or from a second output 208 of the WSS 202 to a first input 210 of the 2×N WSS 204. In normal operation, the (N+1)×2 WSS 202 would be configured to route all the wavelengths from the optical transceivers 110₁ to 110_{N} or 111₁ to 111_{N} to the output 206 directed to the Line TX optical interface 120 or 122, and the 2×N WSS 204 would be configured to route all the wavelengths from a Line RX optical interface 124 or 126 to the optical transceivers 110₁ to 110_{N} or 111₁ to 111_{N} through a second input 212. The second output 208 of the (N+1)×2 WSS 202 and the first input 210 of the 2×N WSS 204, is used to loop back wavelengths from the transmit interface of the optical transceivers 110 or 111 to the receiver interface of the optical transceivers 110₁ to 110_{N} or 111₁ to 111_{N}. Such a function would be used to verify the operation of a given optical transceiver 110₁ to 110_{N} or 111₁ to 111_{N}, and to verify that a given optical transceiver 110₁ to 110_{N} or 111₁ to 111_{N} is correctly fibered to the optical line termination card 106 or 108. This loopback will be referred to as multiplexer loopback. An amplified spontaneous emission (ASE) noise source 216 is fibered to one input of the (N+1)×2 WSS 202. The source 216 used to insert ASE noise into any unused channels of the outgoing DWDM signal (to the TX Line optical interface 120 or 122). This function would be employed whenever there is less than the full complement of optical transceivers 110₁ to 110_{N} or 111₁ to 111_{N} (i.e., less than N optical transceivers 110₁ to 110_{N} or 111₁ to 111_{N} for the case where the wavelengths from N optical transceivers fully occupy the entire optical transmission band, such as the C-band). For example, when bringing up the optical transport network 100 of FIG. 1, initially the entire optical band would be configured with ASE noise, and then as each optical transceiver 110₁ to 110_{N} or 111₁ to 111_{N} is turned up, the channel associated with the optical transceiver 110₁ to 110_{N} or 111₁ to 111_{N} would have its ASE noise substituted with the wavelength from the optical transceiver 110₁ to 110_{N} or 111₁ to 111_{N}. Another example of when the ASE noise source would be used would be for the case where the laser of a given optical transceiver failed. For this case, the WSS would be configured to replace the channel associated with the wavelength of the failed laser with ASE noise. The practice of intentionally injecting ASE noise into vacant wavelength spectrum within a DWDM optical network is typically referred to as “ASE noise fill”, and it is a standard practice in most modern DWDM systems, as it simplifies network management and allows for simplified amplifier designs.

An output amplifier 218 (Output Amp) and the input amplifier 220 (Input Amp) depicted in FIG. 2 can be Erbium Doped Fiber Amplifiers (EDFAs). The EDFAs can be augmented with Raman amplifier technology to achieve longer distances between the two sites 102, 104. In some cases, there can be additional amplification sites between sites 102, 104 (not shown). These additional sites would contain EDFAs (and optionally Raman amplifiers), but typically no optical transceivers.

OLT cards 106, 108 suffer from several deficiencies. First, since the value of N could be quite large (as large as 64 when using 400 Gbps optical transceivers), the number of optical ports on the WSSs 202, 204 would be quite large, thereby making the WSS 202, 204 complex and expensive. Typically, the two WSSs 202, 204 would be packaged together, thereby decreasing the cost by having the two WSSs 202, 204 share some of the optics within the package. Co-packaging the two WSSs 202, 204 also reduces the amount of physical space required by the two WSSs 202, 204 on the optical line termination card, but the complexity remains.

A second problem suffered by OLT cards 106, 108 are the large number of optical connectors required on the front panel of the optical line termination cards 106, 108. For example, for a system using 400 Gbps optical transceivers, 65 dual-LC connectors would be required (64 for the optical transceiver interfaces, and 1 for the Line interface). This means that to accommodate all the optical connectors, either the faceplate of the optical line termination card would need to be quite large, or one or more additional “port expansion” cards would be required to augment an optical line termination card with a smaller faceplate. Generally, for the OLT card architecture depicted in FIG. 2, the overall physical size of the optical line termination card can be dictated by the size of the faceplate rather than by the space needed within the card to accommodate optics and electrical circuitry. As previously mentioned, a method of transporting higher aggregate bit rates between two physical sites is to use multiple fibers. This method of increasing aggregate capacity between two physical sites is referred to as multi-rail optical transport, wherein each bidirectional fiber pair (116 plus 118) represents one rail. FIG. 3 depicts a system where the optical line termination card 106, 108 is duplicated for every additional rail, up to M OLT cards 106₁ to 106_{M} or 108₁ to 108_{M} at each site 102, 104, respectively. Although FIG. 3 represents a plausible method of supporting a multi-rail solution, it is costly from a physical space viewpoint, an electrical power viewpoint, and a monetary viewpoint. Consequently, there is a need in the art for more efficient methods and apparatus to implement a multi-rail solution.

### SUMMARY OF THE DISCLOSURE

Methods and apparatus of routing optical wavelengths over one or more optical fibers from a first physical site to a second physical site. The first physical site could be, for example, a first data center, and the second physical site could be, for example, a second data center. In some embodiments of the present disclosure, an optical apparatus comprises a plurality of first optical interfaces; a plurality of second optical interfaces; a plurality of optical wavelength multiplexers operable to multiplex a first set of wavelengths from a plurality of optical transceivers; a plurality of optical wavelength demultiplexers operable to demultiplex a second set of wavelengths to the plurality of optical transceivers; and a singular wavelength-switching device operable to individually switch wavelengths of the first set of wavelengths from the plurality of optical wavelength multiplexers to the plurality of first optical interfaces and to the plurality of optical wavelength demultiplexers, and operable to individually switch wavelengths of the second set of wavelengths from the plurality of second optical interfaces to the plurality of optical wavelength demultiplexers. In some embodiments of the present disclosure an optical apparatus comprises a plurality of first optical interfaces; a plurality of second optical interfaces; a plurality of optical wavelength multiplexers operable to multiplex a plurality of first wavelengths from a plurality of optical transceivers; a plurality of optical wavelength demultiplexers operable to demultiplex a plurality of second wavelengths to the plurality of optical transceivers; a first singular wavelength-switching device; and a second singular wavelength-switching device, wherein in combination the first singular wavelength-switching device and the second singular wavelength-switching device are operable to individually switch wavelengths of the plurality of first wavelengths from the plurality of optical wavelength multiplexers to the plurality of first optical interfaces and to the plurality of optical wavelength demultiplexers, and operable to individually switch wavelengths of the plurality of second wavelengths from the plurality of second optical interfaces to the plurality of optical wavelength demultiplexers. In some embodiments of the present disclosure, an optical apparatus comprises a plurality of first optical interfaces; a plurality of optical wavelength multiplexers operable to multiplex a plurality of first wavelengths from a plurality of optical transceivers; and a singular wavelength-switching device operable to individually switch wavelengths of the plurality of first wavelengths from the plurality of optical wavelength multiplexers to the plurality of first optical interfaces. Further embodiments of the present disclosure are discussed below.

### BRIEF DESCRIPTION OF THE DRAWINGS

To assist in understanding the present disclosure, reference is now made to the following description taken in conjunction with the accompanying drawings, in which:

FIG. 1 depicts an optical transport network in accordance with the prior art.

FIG. 2 depicts an optical line termination card in accordance with the prior art.

FIG. 3 depicts a system having N optical line termination cards for N rails in accordance with the prior art.

FIG. 4A depicts an optical apparatus in accordance with some embodiments of the present disclosure.

FIGS. 4B to 4E depict embodiments of multiplexers and demultiplexers in accordance with some embodiments of the present disclosure.

FIG. 5 depicts a multi-rail optical transport network in accordance with some embodiments of the present disclosure.

FIG. 6 depicts an optical apparatus in accordance with some embodiments of the present disclosure.

FIG. 7 depicts an optical line termination card in accordance with some embodiments of the present disclosure.

FIG. 8 depicts an optical apparatus in accordance with some embodiments of the present disclosure.

FIG. 9 depicts an optical apparatus in accordance with some embodiments of the present disclosure.

FIG. 10 depicts an optical line termination card in accordance with some embodiments of the present disclosure.

FIG. 11 depicts an optical line termination card in accordance with some embodiments of the present disclosure.

FIG. 12 depicts an optical line termination card in accordance with some embodiments of the present disclosure.

FIG. 13 depicts an optical line termination card in accordance with some embodiments of the present disclosure.

FIG. 14 depicts an optical line termination card in accordance with some embodiments of the present disclosure.

FIG. 15 depicts an optical apparatus in accordance with some embodiments of the present disclosure.

FIG. 16 depicts an optical line termination card in accordance with some embodiments of the present disclosure.

FIG. 17 depicts utilized paths within a pair of 2×2 wavelength selective switches in accordance with some embodiments of the present disclosure.

FIG. 18 depicts utilized paths within the pair of 2×2 wavelength selective switches in accordance with some embodiments of the present disclosure.

FIG. 19 depicts utilized paths within the pair of 2×2 wavelength selective switches in accordance with some embodiments of the present disclosure.

FIG. 20 depicts an optical line termination card in accordance with some embodiments of the present disclosure.

FIG. 21 depicts an optical line termination card in accordance with some embodiments of the present disclosure.

### DETAILED DESCRIPTION

In the foregoing description, the disclosure is described with reference to specific example embodiments thereof. It will, however, be evident that various modifications and changes can be made thereto without departing from the scope of the present disclosure. The specification and drawings are accordingly to be regarded in an illustrative rather than restrictive sense.

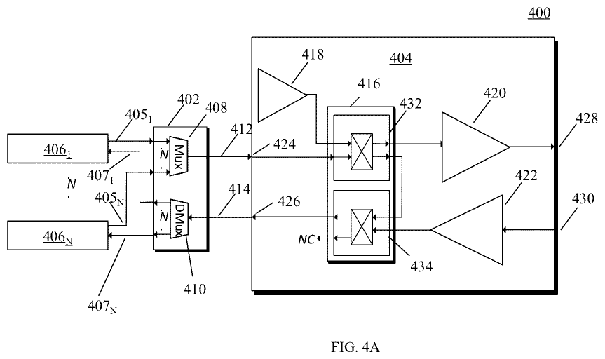

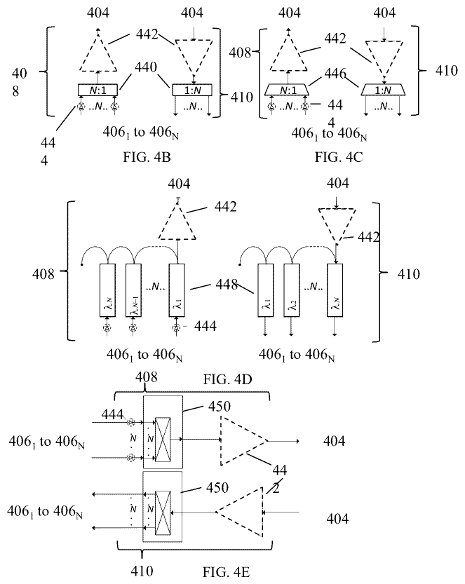

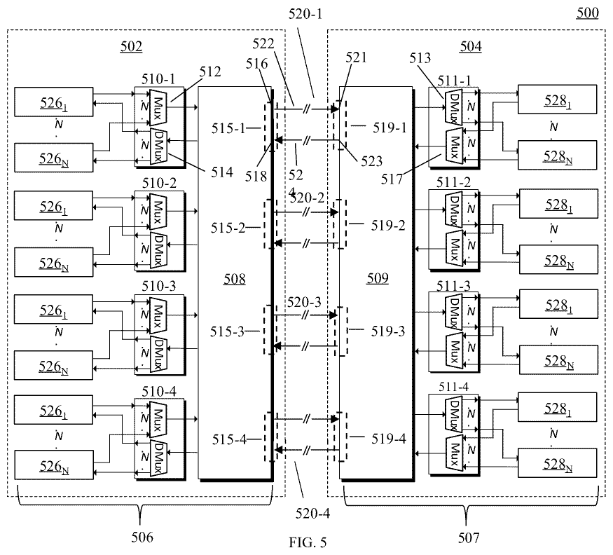

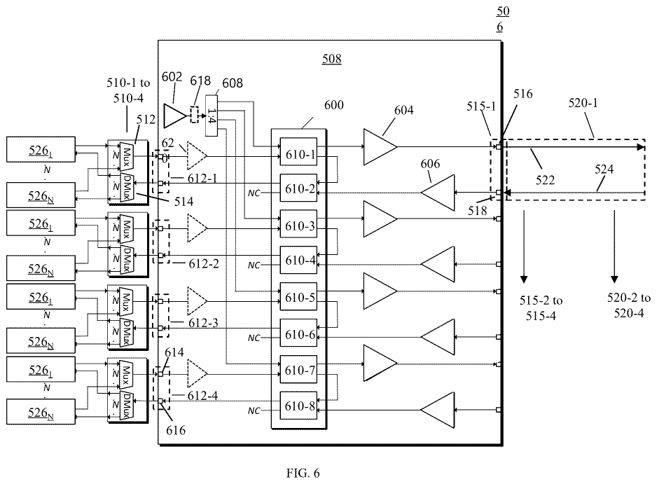

FIG. 4A depicts an optical apparatus 400 comprising a multiplexer/demultiplexer 402 (Mux/DMux) and an optical line termination (OLT) card 404 in accordance with some embodiments of the present disclosure. In the embodiment of FIG. 4A, the optical line termination card 404 does not multiplex optical wavelengths 405₁ to 405_{N} from a plurality of optical transceivers 406, nor does it demultiplex optical wavelengths 407₁ to 407_{N} to the plurality of optical transceivers 406₁ to 406_{N}. Instead, the multiplexing and demultiplexing of optical wavelengths 405₁ to 405_{N}, 407₁ to 407_{N} can be done externally to the optical line termination card 404, by the multiplexer/demultiplexer 402, e.g., an optical wavelength multiplexer 408 can be used to multiplex the optical wavelengths 405₁ to 405_{N}, and an optical wavelength demultiplexer 410 can be used to demultiplex optical wavelengths 407₁ to 407_{N}, where the multiplexer 408 and demultiplexer 410 are external to the OLT card 404. Therefore, the optical line termination card 404 receives a single first DWDM signal 412 from the multiplexer 408 and generates a single second DWDM signal 414 to the demultiplexer 410. The optical line termination card 404 comprises of a 2×2 wavelength selective switch (WSS) array 416, an ASE noise source 418, an output amplifier 420 (Output Amp), an input amplifier 422 (Input Amp), an optical interface 424 to the Mux, and optical interface 426 to the DMux, and optical interface to 428 the transmit optical fiber (e.g., Line TX), and an optical interface 430 to the receive optical fiber (e.g., Line RX).

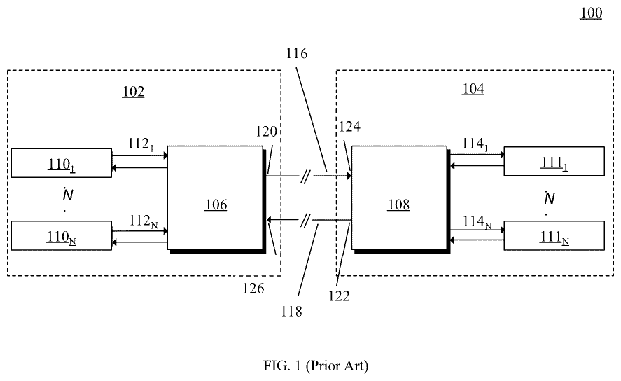

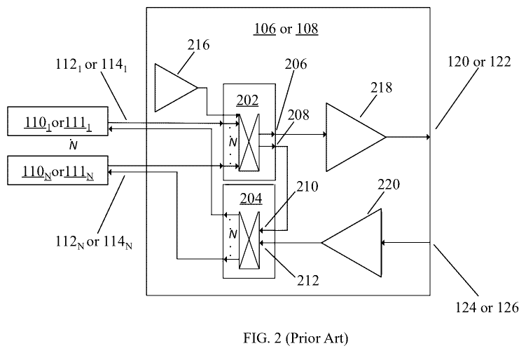

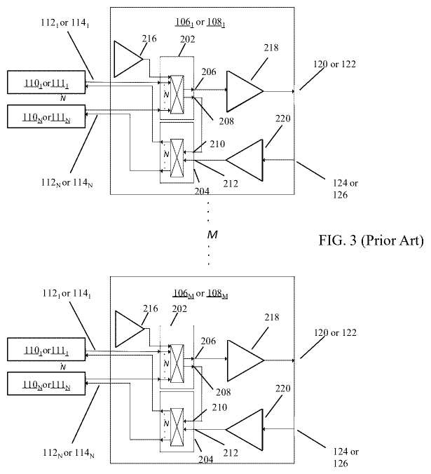

The optical apparatus 400 can be used to replace the optical line termination cards 106, 108 in the optical transport network 100 depicted in FIG. 1. Alternatively (not depicted in FIG. 4A), the optical line termination card 404 can include the multiplexer/demultiplexer 402. Alternatively (also not depicted in FIG. 4A), the optical line termination card 404 can include the multiplexer/demultiplexer 402 and the optical transceivers 406₁ to 406_{N}. Alternatively (not depicted in FIG. 4A), the multiplexer/demultiplexer 402 and the optical transceivers 406₁ to 406_{N} can be integrated into an integrated circuit card.

The multiplexer and demultiplexer 408, 410 have fixed DWDM channel spacing, and are purposely designed to operate with N optical transceivers 406₁ to 406_{N} all operating with the same optical modulation format and rate. Therefore, all the N optical transceivers 406₁ to 406_{N} require the same channel spacing because the network 100 can be a point-to-point optical network, wherein all wavelengths are generated at a first site 102 and all wavelengths are terminated at a second site 104. For instance, all N optical transceivers 406₁ to 406_{N} can generate 1.6 Tbps wavelengths requiring 300 GHz channel spacing. For this case, the multiplexer and demultiplexer 408, 410 would have a channel spacing of 300 GHz. If instead, all N optical transceivers 406₁ to 406_{N} generate 800 Gbps wavelengths requiring 150 GHz channel spacing, the multiplexer and demultiplexer 408, 410 would have a channel spacing of 150 GHz. The channel spacing of the multiplexer and demultiplexer 408, 410 would be designed to accommodate the highest bit rate which a given network could operate. Then, if there was a temporary network impairment due to an impairment of the interconnecting fiber or due to the optical transport equipment itself, a multi-rate optical transceiver could reduce its bit rate, while still utilizing the same multiplexer and demultiplexer.

The multiplexer and demultiplexer 408, 410 could be implemented with technology requiring no electrical power. For example, the multiplexer and demultiplexer 408, 410 could each be implemented with an athermal Arrayed Waveguide Grating (AWG). In some embodiments, the multiplexer and demultiplexer 408, 410 could each be implemented using a plurality of interference filters (such as thin-film filters) that allow one specific wavelength to pass through while reflecting other wavelengths. In some embodiments, the multiplexer and demultiplexer 408, 410 could each be implemented using optical couplers (such as fused tap couplers). In some embodiments, the multiplexer and demultiplexer 408, 410 could be implemented with technology requiring electrical power, such as an AWG requiring temperature control, or an AWG paired with a plurality of photo detectors (to measure the laser power of each of the optical transceivers prior to the multiplexing process). In some embodiments, an optical amplifier could be used within the multiplexer to amplify its generated DWDM signal. In some embodiments, an optical amplifier could be used within the demultiplexer to amplify its received DWDM signal. In some embodiments, the multiplexer and demultiplexer 408, 410 could be implemented with N×1 and 1×N WSS devices. By separating the multiplexer and demultiplexer 408, 410 from the optical line termination card, one can utilize different multiplexers and demultiplexers with a common optical line termination card, depending upon a given application.

FIGS. 4B through 4E depict various embodiments of the multiplexer 408 and demultiplexer 410 that can be used with the (OLT) card 404 in the optical apparatus 400. Though described with respect to the optical apparatus 400, the embodiments of the multiplexer 408 and demultiplexer 410 can be utilized with any embodiments of the optical apparatus of the present disclosure.

FIG. 4B depicts the optical multiplexer 408 and demultiplexer 410, where each comprises an optical coupler 440 and optionally an amplifier 442. The multiplexer 408 can further comprise an optional photodiode 444 between the optical coupler 440 and the transceivers 406₁ to 406_{N}.

FIG. 4C depicts the optical multiplexer 408 and demultiplexer 410, where each comprises an arrayed waveguide grating (AWG) 446 and optionally the amplifier 442. The multiplexer 408 can further comprise the optional photodiode 444 between the AWG 446 and the transceivers 406 to 406_{N}.

FIG. 4D depicts the optical multiplexer 408 and demultiplexer 410, where each comprises a plurality of thin-film filters 448 and optionally the amplifier 442. The multiplexer 408 can further comprise the optional photodiode 444 between the plurality of thin-film filters 448 and the transceivers 406₁ to 406_{N}.

FIG. 4E depicts the optical multiplexer 408 and demultiplexer 410, where each includes a WSS 450 and optionally the amplifier 442. The multiplexer 408 can further comprise the optional photodiode 444 between the WSS 450 and the transceivers 406₁ to 406_{N}.

If the multiplexer/demultiplexers depicted in FIGS. 4B and 4D are implemented without the amplifier 442 and without the photodiode 444, then the multiplexer/demultiplexers can be placed within passive (i.e., no electrical power) enclosures, separate from the enclosure containing the OLT 404. If the multiplexer/demultiplexer depicted in FIG. 4C is implemented with athermal AWGs and without the amplifier 442 and without the photodiode 444, then the multiplexer/demultiplexer can also be placed within a passive enclosure, separate from the enclosure containing the OLT 404. If the multiplexer/demultiplexers depicted in FIGS. 4B to 4E are implemented with either the amplifier 442 or with the photodiode 444, the multiplexer/demultiplexers must be placed within an enclosure having electrical power. Multiplexer and demultiplexer implementations requiring electrical power can be placed in the same enclosure as the OLT card, or they can be placed in an enclosure separate from the OLT card.

The 2×2 wavelength selective switch (WSS) array 416 (and all the singular wavelength-switching devices disclosed herein) can be of the type described in the U.S. Pat. No. 9,588,299, which is incorporated herein by reference in its entirety. Such an array is a singular wavelength-switching device, as it shares a common optical train (i.e., optical assembly), including optical lenses, an optical grating, and a single (i.e., singular) polarization modulation array used to perform the actual wavelength switching. Furthermore, the singular polarization modulation array can be implemented with a single liquid crystal on silicon (LOCS) chip. Or alternatively, the singular polarization modulation array can be implemented with a liquid crystal cell array that includes a plurality of pixel cells. Or alternatively, the singular polarization modulation array can be implemented with a thin-film transistor liquid crystal panel.

The 2×2 wavelength selective switch (WSS) array 416 can be an array of two 2×2 wavelength selective switches 432, 434, but an array with a larger number of 2×2 wavelength selective switches could be used within the optical apparatus 400 (with one of more 2×2 wavelength selective switches going unused or used for different purposes). Also, instead of using a two element 2×2 wavelength selective switch array 416, the singular wavelength-switching device 416 could be implemented as a 2×2 wavelength selective switch (for switch 432) and a 2×1 wavelength selective switch (for switch 434). For example, as depicted in FIG. 4A, WSS 434 has a port that is not connected (NC) and therefore the 2×1 WSS 434 can be replaced with a 2×1 WSS.

The optical line termination card 404 could further comprise of an optical amplifier (not shown in FIG. 4) to amplify the DWDM signal from the multiplexer (prior to the signal being forwarded to the WSS), and an optical amplifier (not shown in FIG. 4) to amplify the DWDM signal to the demultiplexer (after the signal leaves the WSS).

For a specific DWDM channel spacing, the optical apparatus 400 would perform the same functionality as the optical line termination cards 106, 108, but with potentially less cost, less complexity, less physical space, and less electrical power.

FIG. 5 depicts a multi-rail optical transport network 500 having a first physical site 502, and a second physical site 504. The two sites can be separated by some amount of physical distance (such as one or more kilometers). At site 502 is a first optical apparatus 506 comprising an optical line termination card 508, a plurality of optical wavelength multiplexers 512, a plurality of optical wavelength demultiplexers 514, a plurality of first optical (line) interfaces 516, and a plurality of second optical (line) interfaces 518. The sites 502 and 504 can be connected by a plurality of first optical fibers 522 and a plurality of second optical fibers 524. The multiplexers 512 and demultiplexers 514 can be arranged in a plurality of first sets 510-1 to 510-4, where each first set has an optical wavelength multiplexer 512 and optical wavelength demultiplexer 514. The first and second optical (line) interfaces 516, 518 can be arranged in a plurality of second sets 515-1 to 515-4, where each second set has a first optical line interface 516 and a second optical line interface 518. The first and second optical fibers 522, 524 can be arranged in a plurality of rails 520-1 to 520-4, where each rail comprises a first optical fiber 522 and a second optical fiber 524. The plurality of second sets 515-1 to 515-4 connects to the plurality of rails 520-1 to 520-4, wherein each first optical line interface 516 connects to a first optical fiber 522 and each second optical line interface 518 connects to a second optical fiber 524.

At Site 504 is a second optical apparatus 507 that can be substantially the same or similar to the first optical apparatus. The second optical apparatus 507 comprises an optical line termination card 509, a plurality of optical wavelength demultiplexers 513, a plurality of optical wavelength multiplexers 517, a plurality of first optical (line) interfaces 523, and a plurality of second optical (line) interfaces 521. The demultiplexers 513 and multiplexers 517 can be arranged in a plurality of first sets 511-1 to 511-4, where each first set has an optical wavelength demultiplexer 513 and optical wavelength multiplexer 517. The first and second optical (line) interfaces 521, 523 can be arranged in a plurality of second sets 519-1 to 519-4, where each second set has a first optical line interface 523 and a second optical line interface 521. The plurality of second sets 519-1 to 519-4 connects to the plurality of rails 520-1 to 520-4, wherein each first optical line interface 523 connects to a first optical fiber 524 and each second optical line interface 521 connects to a second optical fiber 522.

The multiplexers 512, 517 and demultiplexers 513, 514 can alternatively be located on the optical line termination cards 508, 509 (not depicted in FIG. 5). The multiplexers 512, 517, demultiplexers 513, 514, and optical transceivers 526, 528 can alternatively be located on the optical line termination cards 508, 509 (also not depicted in FIG. 5). Alternatively, the optical transceivers 526₁ to 526_{N} attached to a particular multiplexer/demultiplexer set (510-1, for example), can be located together on an individual circuit card or enclosure (also not depicted in FIG. 5). For example, based on the embodiments of FIG. 5, there could be up to eight individual circuit cards containing the optical transceivers 526₁ to 526_{N}. For this later case, the circuit card containing the multiplexer/demultiplexer set and its corresponding optical transceivers 526₁ to 526_{N} can be optically connected to the optical line termination card 508, 509 via dual-fiber optical jumper, wherein the jumper cable can connect the two cards via connectors on the front panels of the two cards or via blind-mate optical connectors located on each card and the backplane of a chassis holding the two cards. Alternatively, more than one multiplexer/demultiplexer set and their corresponding optical transceivers can be placed a given circuit card or enclosure (for example: multiplexer/demultiplexer sets 510-1, 510-2 and their corresponding optical transceivers 526₁ to 526_{N} can be placed on a single circuit card, or multiplexer/demultiplexer sets 510-1 to 510-4 and their corresponding optical transceivers 526₁ to 526_{N} can be placed on a single circuit card). Alternatively, for the case wherein the multiplexers, demultiplexers sets 510-1 to 510-2 are located on the OLT card, one or more sets of optical transceivers sets 526₁ to 526_{N} can be placed on a single circuit card, and then connect to the OLT card via either front panel optical jumper cables or via blind-mate optical backplane connections.

The first optical apparatus 506 can be connected to the second optical apparatus 507 without any intervening optical transport equipment, or the first optical apparatus 506 can be connected to the second optical apparatus 507 with intervening optical transport equipment, such as optical amplifiers. As such, there can be a plurality of additional physical sites between site 502 and site 504, with each additional site containing optical amplifiers to amplify the optical power of a first set of wavelengths generated by a plurality of optical transceivers located in site 502, and with each additional site containing optical amplifiers to amplify the optical power of a second set of wavelengths generated by a plurality of optical transceivers located in site 504.

Each multiplexer 512, 517 and demultiplexer 513,514 within a given first set 510-1 to 510-4, 511-1, 511-4 multiplexes and demultiplexes the wavelengths of N optical transceivers 526₁ to 526_{N}, 528₁ to 528_{N} that are optically connected to the first set 510-1 to 510-4, 511-1, 511-4. The optical multiplexers and demultiplexers can be of the type(s) described in reference to FIG. 4B to 4E or can be multiplexers and demultiplexers based on other technology. Although the first optical apparatus 506 and second optical apparatus 507 depicted in FIG. 5 utilize four first sets of multiplexers and demultiplexers, the number of multiplexer and demultiplexer sets can be less than four or more than four.

FIG. 6 depicts the first optical apparatus 506 in accordance with some embodiments of the present disclosure. The embodiments of FIG. 6 can also be utilized for the second optical apparatus 507 (not shown in FIG. 6) The first optical apparatus 506 includes the OTL card 508, the plurality of optical wavelength multiplexers 512 and the plurality of optical wavelength demultiplexers 514 (arranged in the plurality of first sets 510-1 to 510-4), and the plurality of first optical (line) interfaces 516 and the plurality of second optical (line) interfaces 518 (arranged in the plurality of second sets 515-1 to 515-4). The plurality of second sets 515-1 to 515-4 connects to the plurality of rails 520-1 to 520-4, wherein each rail comprises the first optical fiber 522 and the second optical fiber 524, and wherein each first optical line interface 516 connects to the first optical fiber 522 and each second optical line interface 518 connects to the second optical fiber 524.

The four rails 520-1 to 520-4 (e.g., eight optical fibers—four first optical fibers 522 and four second optical fibers 524) depicted in FIGS. 5-6 attach to the optical line termination card 506 as follows: the four first optical fibers 522 are attached via respective first optical (line) interfaces 516 in first sets 515-1 to 515-4, and the four second optical fibers 524 are attached via respective second optical (line) interfaces 518 in the first sets 515-1 to 515-54. Similarly, the OLT card 509 (depicted in FIG. 5) attach to the four second optical fibers 524 via the respective first optical (line) interfaces 523 in the first sets 519-1 to 519-4, where the first optical (line) interfaces 523 of the OLT card 509 are equivalent to the first optical (line) interfaces 516 of the OLT card 508, and the four first optical fibers 522 are attached via the respective optical (line) interfaces 521 in the first sets 519-1 to 519-4, where the optical (line) interfaces 521 of the OLT card 509 are equivalent to the optical (line) interfaces 518 of the OLT card 508.

The optical line termination card 508 as depicted in FIG. 6 further comprises a singular wavelength-switching device 600 (e.g., a 2×2 wavelength selective switch (WSS) array), an amplified spontaneous emission (ASE) noise source 602, a plurality of output amplifiers 604, a plurality of input amplifiers 606, an optical coupler 608 used to broadcast ASE noise to a plurality of the wavelength selective switches 610-1 to 610-8 within the singular wavelength-switching device 600, a plurality of multiplexer interfaces 614, and a plurality of demultiplexer interfaces 616. The multiplexer interfaces 614 and demultiplexer interfaces 616 can be arranged in third sets 612-1 to 612-4, where each third set comprises a multiplexer interface 614 and a demultiplexer interface 616 and couples to a multiplexer 512 and demultiplexer 514, respectively, of a corresponding first set 510-1 to 510-4.

The plurality of N×4 optical transceivers 526₁ to 526_{N} depicted in FIGS. 5-6 generate a first set of wavelengths, while a second set of wavelengths can be received from the plurality of second optical (line) interfaces 518. The first set of wavelengths can be received at the optical line termination card 508 via the multiplexer interfaces 614.

The single wavelength switching device 600 can be a 2×2 wavelength selective switch (WSS) array as described in the U.S. Pat. No. 9,588,299 , the entirety of which is incorporated by reference herein. Moreover, any single wavelength switching device disclosed herein can be as described in the above-referenced U.S. Patent. Such an array is a singular wavelength-switching device, ‘singular’ meaning that the device shares a common optical train (i.e., optical assembly), including optical lenses, an optical grating, and a single (i.e., singular) polarization modulation array used to perform the actual wavelength switching between the WSS of the device. Furthermore, the singular polarization modulation array can be implemented with a single liquid crystal on silicon (LOCS) chip. Or alternatively, the singular polarization modulation array can be implemented with a liquid crystal cell array that includes a plurality of pixel cells. Or alternatively, the singular polarization modulation array can be implemented with a thin-film transistor liquid crystal panel.

The device 600 can be used to switch the first set of wavelengths from the plurality of optical wavelength multiplexers 512 to the plurality of first optical (line) interfaces 516 and the second set of wavelengths from the plurality of second optical (line) interfaces 518 to the plurality of optical wavelength demultiplexers 514. In some embodiments, the device 600, can be used to replace at least one wavelength of the first set of wavelengths with amplified spontaneous emission noise from the ASE noise source 602. In some embodiments, the device 600 can be used to loop back one or more wavelengths of the first set of wavelengths to the plurality of optical wavelength demultiplexers.

The singular wavelength-switching device 600 can a plurality of I×J wavelength selective switches wherein each I×J wavelength-selective-switch of the plurality of I×J wavelength selective switches comprise I input ports and J output ports. In the embodiments of FIG. 6, each switch 610-1 to 610-8 can be a 2×2 WSS, i.e., I=2 and J=2. However, in some embodiments (not shown in FIG. 6), I can be greater than 2 and/or J can be greater than 2.

The individual WSS 610-1 to 610-8 within the singular wavelength-switching device 600 can perform two different types of functions. A first plurality of WSS 610-1, 610-3, 610-5 and 610-7 can perform a first function (i.e., ASE noise fill and switching the first set of wavelengths to the first optical interfaces 516), and a second plurality of WSS 610-2, 610-4, 610-6, and 610-8 can perform a second function (i.e., switching the second set of wavelengths to the demultiplexer interfaces 616 and looping back the first set of wavelengths from the first plurality of WSS 610-1, 610-3, 610,5 and 610-7). Further, every WSS can be capable of individually attenuating individual wavelengths by programmable amounts. The singular wavelength-switching device 600 can be generalized as comprising a plurality of M×N wavelength selective switches (e.g., the first plurality of WSS 610-1, 610-3, 610-5, and 610-7), wherein each M×N wavelength-selective-switch of the plurality of M×N wavelength selective switches comprise M input ports and N output ports, and a plurality of K×L wavelength selective switches (e.g., the second plurality of WSS 610-2, 610-4, 610-6, and 610-8), wherein each K×L wavelength-selective-switch of the plurality of K×L wavelength selective switches comprise K input ports and L output ports.

Any given wavelength of the first set of wavelengths from a given optical wavelength multiplexer 512 can be independently switched by its associated M×N WSS 610-1, 610-3, 610-5, 610-7 to one of its associated first optical line interface 516, to its associated K×L WSS 610-2, 610-4, 610-6, 610-8, or to neither associated first optical line interface 516 nor its associated K×L wavelength selective switch 610-2, 610-4, 610-6, 610-8. The latter case can occur when a given wavelength is not being looped back to its associated demultiplexer 514, and the given wavelength is being substituted with ASE noise from the ASE noise source 602 at an associated first optical line interface 516 of M×N WSS 610-1, 610-3, 610-5, 610-7.

Each wavelength from a given K×L WSS 610-2, 610-4, 610-6, 610-8 can be independently switched from its associated second optical line interface 518, or from the associated M×N wavelength selective switch of the plurality of M×N WSS 610-1, 610-3, 610-5, 610-7.

The plurality of M×N WSS 610-1, 610-3, 610-5, 610-7 can switch the first set of wavelengths from the plurality of optical wavelength multiplexers 512 to the plurality of first optical (line) interfaces 516 and can replace at least one wavelength of the first set of wavelengths with the amplified spontaneous emission noise from the ASE noise source 602. The plurality of K×L WSS 610-2, 610-4, 610-6, 610-8 can switch the second set of wavelengths from the plurality of second optical (line) interfaces 518 to the plurality of optical wavelength demultiplexers 514. M can be at least 2, and N can be at least 2. K can be at least 2, and L can be at least 1. As depicted in FIG. 6, M, N, K, and L are each 2. Additionally, the plurality of M×N WSS 610-1, 610-3, 610-5, 610-7 can switch one or more of the first set of wavelengths from the plurality of optical wavelength multiplexers 512 to the plurality of K×L WSS 610-2, 610-4, 610-6, 610-8 (i.e., a multiplexer 512 to demultiplexer 514 loop back function, or simply multiplexer loopback), and the plurality of K×L WSS 610-2, 610-4, 610-6, 610-8 can switch the one or more of the first set of wavelengths from the plurality of M×N WSS 610-1, 610-3, 610-5, 610-7 to the plurality of optical wavelength demultiplexers 514. Although M is equal to 2 in the optical apparatus 506 as depicted in FIG. 6, M can be greater than 2. Although N is equal to 2 in the optical apparatus 506 as depicted in FIG. 6, N can be greater than 2. Although K is equal to 2 in the optical apparatus 506 as depicted in FIG. 6, K can be greater than 2. Although L is equal to 2 in the optical apparatus 506 as depicted in FIG. 6, K can be less than 2, or K can be greater than 2.

Although there are four rails 520-1 to 520-4 (e.g., four first optical line fibers 522 and four second optical line fibers 524) supported by the OLT card 508 as depicted in FIG. 6, the present disclosure is not limited to an OLT card that supports up to four rails. Any number of rails can be supported by the OLT cards disclosed herein including less than four or greater than four. Scaling the number of supported rails up or down would be accomplished by increasing or decreasing the number of M×N WSS and K×L WSS in the singular wavelength-switching device.

Generally, and depicted in FIG. 6 (and in site 502 of FIG. 5) there is an optical apparatus 506, comprising: a plurality of first optical (line) interfaces 516, connected to a plurality of first optical line fibers 522; a plurality of second optical (line) interfaces 518, connected to a plurality of second optical line fibers 524; a plurality of optical wavelength multiplexers 512, used to multiplex a first set of wavelengths from a plurality of optical transceivers (e.g., 4N optical transceivers) 526₁ to 526_{N}; a plurality of optical wavelength demultiplexers 514, used to demultiplex a second set of wavelengths from the plurality of second optical (line) interfaces 518 to the plurality of optical transceivers (e.g., 4N optical transceivers) 526₁ to 526_{N}; and a singular wavelength-switching device 600 to switch the first set of wavelengths from the plurality of optical wavelength multiplexers 512 to the plurality of first optical (line) interfaces 516 and the second set of wavelengths from the plurality of second optical (line) interfaces 518 to the plurality of optical wavelength demultiplexers 514.

In some embodiments, the OTL card 508 can include a variable optical attenuator (VOA) 618 that is used to attenuate ASE noise provided by the ASE noise source 602 to each of the M×N WSS 610-1, 610-3, 610-5, 610-8. The VOA 618 can be an electrically variable optical attenuator (EVOA) and can attenuate the ASE by a programmable amount of attenuation. As depicted in FIG. 6, the VOA 618 can be disposed between the ASE noise source 602 and the optical coupler 608.

In some embodiments, the OTL card 508 can include additional optical amplifiers 620 are added between each multiplexer interface 614 and corresponding WSS 610-1, 610-3, 610-5, 610-7. Additional optical amplifiers can also be placed between the plurality of K×L WSS 610-2, 610-4, 610-6, 610-8 and the demultiplexer interfaces 616 (not shown in FIG. 6).

As depicted in FIG. 6, each of the K×L WSS 610-2, 610-4, 610-6, 610-8 have a second output that is a “not connected” (NC) output. As depicted in FIG. 6, each of the K×L WSS 610-2, 610-4, 610-6, 610-8 are 2×2 WSS. Alternatively, in some embodiments, each of the K×L WSS 610-2, 610-4, 610-6, 610-8 can be replaced with 2×1 WSS within the singular wavelength-switching device (not shown in FIG. 6). Therefore, for this case, K is equal to 2 and L is equal to 1. Using a combination 2×2/2×1 WSS array simplifies the singular wavelength-switching device if the second output of the K×L wavelength selective switch is not being utilized.

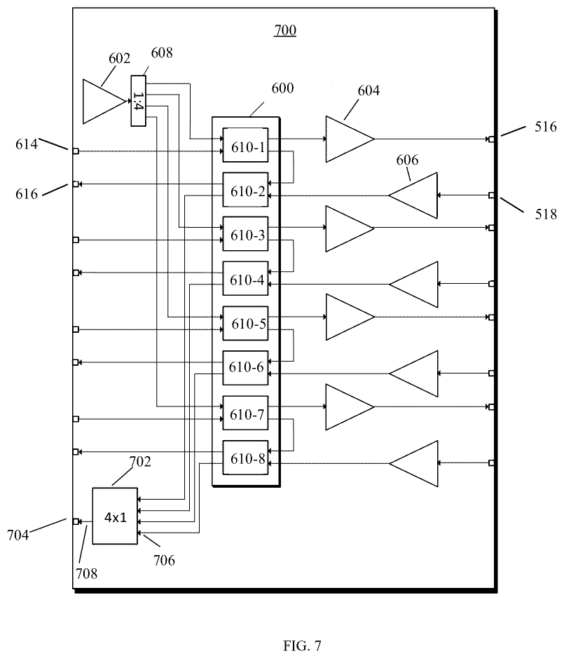

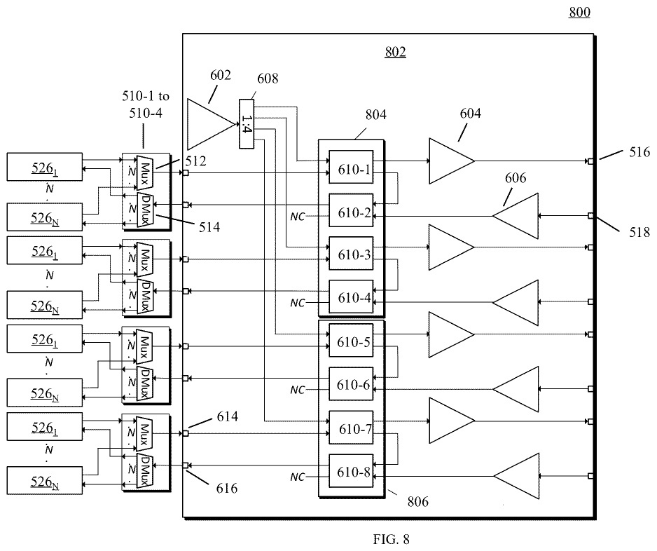

FIG. 7 depicts an OLT card 700 that is substantially the same as the OLT card 508 as depicted in FIG. 6, except that the second output of each of the K×L WSS 610-2, 610-4, 610-6, 610-8, which is depicted as a “not connected” (NC) output in the OLT card 508, is connected to a 4×1 broadband optical switch 702, that is in turn connected to an optical test port 704. The broadband optical switch 702 is configured to switch all of the wavelengths entering a given input 706 to an output 708 of the switch 702. The switch 702 cannot selectively switch individual wavelengths from a given input 706 to the output 708. The switch 702 is a simpler switch compared to a 4×1 wavelength selective switch, which is capable of selectively switching individual wavelengths. The optical test port 704 can be used to attach the OLT card 700 to an optical test instrument, such as an optical spectrum analyzer (not shown in FIG. 7). In an alternative embodiment to using the 4×1 broadband optical switch 702 to forward wavelengths to the single optical test port 704, four optical test ports could be added to the optical line termination card 700 (not shown in FIG. 7), wherein the second output from each of the K×L WSS 610-2, 610-4, 610-6, 610-8 can be connected to one of the four optical test ports. In yet another alternative embodiment, unused 2×2 wavelength selective switches within a larger 2×2 wavelength selective switch array (not shown in FIG. 7) could be used to switch wavelengths from the K×L WSS 610-2, 610-4, 610-6, 610-8 to a single optical test port. Three additional 2×2 wavelength selective switches (or 2×1 wavelength selective switches) can be required to route any wavelength from any of the four K×L WSS 610-2, 610-4, 610-6, 610-8 to a single optical test port. Such an implementation can allow wavelengths from any optical wavelength multiplexer 512 or any of the plurality of second optical (line) interfaces 518 to simultaneously be forwarded to the optical test port 704, provided none of the wavelengths are of the same frequency.

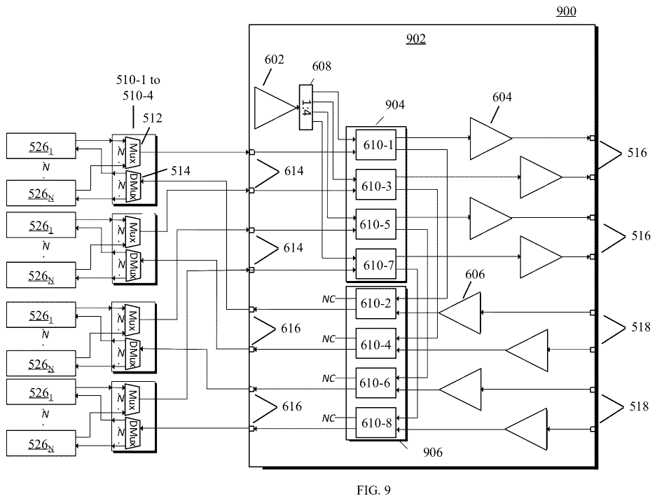

FIG. 8 depicts an optical apparatus 800 having an OLT card 802 that is substantially the same as the optical line termination card 508 depicted in FIG. 6, except the singular WSS device 600 is replaced with a first singular WSS device 804 including WSS 610-1 to 610-4 and a second singular WSS device 806 including WSS 610-5 to 610-8. The WSS devices 804, 806 can switch a first set of wavelengths from the plurality of optical wavelength multiplexers 512 to the plurality of first optical interfaces 516 and a second set of wavelengths from the plurality of second optical interfaces 518 to the plurality of optical wavelength demultiplexers 514.

For example, the first singular wavelength-switching device 804 can switch a first subset of the first set of wavelengths from a first subset of the plurality of optical wavelength multiplexers 512 to a first subset of the plurality of first optical interfaces 516, and for switching a first subset of the second set of wavelengths from a first subset of the plurality of second optical interfaces to a first subset of the plurality of optical wavelength demultiplexers 514. For example, the second singular wavelength-switching device 806 can switch a second subset of the first set of wavelengths from a second subset of the plurality of optical wavelength multiplexers 514 to a second subset of the plurality of first optical interfaces 516 and a second subset of the second set of wavelengths from a second subset of the plurality of second optical interfaces 518 to a second subset of the plurality of optical wavelength demultiplexers 514.

Each of the first and second singular wavelength-switching devices 804, 806 can include a plurality of M×N wavelength selective switches 610-1, 610-3, 610-5, 610-7 and a plurality of K×L wavelength selective switches 610-2, 610-4, 610-6, 610-8, wherein each M×N wavelength selective switch comprises M input ports and N output ports, wherein each K×L wavelength selective switch comprises K input ports and L output ports.

In the first singular wavelength-switching device 804, each M×N wavelength selective switch 610-1, 610-3 can switch the first subset of the first set of wavelengths from the first subset of the plurality of optical wavelength multiplexers 512 to the first subset of the plurality of first optical interfaces 516, and wherein each K×L wavelength selective switch 610-2, 610-4 can switch the first subset of second set of wavelengths from the first subset of the plurality of second optical interfaces 518 to the first subset of the plurality of optical wavelength demultiplexers 514.

In the second singular wavelength-switching device 806, each M×N wavelength selective switch 610-5, 610-7 can switch the second subset of the first set of wavelengths from the second subset of the plurality of optical wavelength multiplexers 512 to the second subset of the plurality of first optical interfaces 516, and wherein each K×L wavelength selective switch 610-6, 610-8 can switch the second subset of second set of wavelengths from the second subset of the plurality of second optical interfaces to the second subset of the plurality of optical wavelength demultiplexers.

In some embodiments, and depicted in FIG. 8, M, N, K and L can be 2. In some embodiments, and not shown in FIG. 8, M, N, K can be 2 and L can be 1. For example, the K×L switches 610-2, 610-4, 610-6, and 610-8, which are 2×2 switches and have an “NC” (No Connection) port in FIG. 8, can be replaced by 2×1 switches.

In the first singular wavelength-switching device 804, each M×N wavelength selective switch 610-1, 610-3 can further switch the first subset of the first set of wavelengths from the first subset of the plurality of optical wavelength multiplexers 512 to one K×L wavelength selective switch 610-2, 610-4, and wherein each K×L wavelength selective switch can further switch the first subset of first set of wavelengths from one M×N wavelength selective switch to the first subset of the plurality of optical wavelength demultiplexers 514.

In the second singular wavelength-switching device 806, each M×N wavelength selective switch 610-5, 610-7 can further switch the second subset of the first set of wavelengths from the second subset of the plurality of optical wavelength multiplexers 512 to one K×L wavelength selective switch 610-6, 610-8, and wherein each K×L wavelength selective switch can further switch the second subset of first set of wavelengths from one M×N wavelength selective switch to the second subset of the plurality of optical wavelength demultiplexers 514.

The OLT 802 can further comprise the amplified spontaneous emission (ASE) noise source 602 used to generate ASE noise. In first singular wavelength-switching device 804, each M×N wavelength selective switch 610-1, 610-3 can be capable of selectively substituting at least one wavelength of the first subset of the first set of wavelengths with the ASE noise from the ASE noise source 602. In the second singular wavelength-switching device 806, each M×N wavelength selective switch 610-5, 610-7 can be capable of selectively substituting at least one wavelength of the second subset of the first set of wavelengths with the ASE noise from the ASE noise source 602.

FIG. 9 depicts an optical apparatus 900 comprising an optical line termination card 902 and the plurality of optical wavelength multiplexers 512 and the plurality of optical wavelength demultiplexers 514 (arranged in first sets 510-1 to 510-4). The OLT card 902 is substantially the same as the optical line termination card 802 depicted in FIG. 8, except that a first singular WSS device 904 switches a first set of wavelengths from the plurality of optical wavelength multiplexers 512 to the plurality of first optical (line) interfaces 516, and a second singular WSS device 906 is used to switch a second set of wavelengths from the plurality of second optical (line) interfaces 518 to the plurality of optical wavelength demultiplexers 514.

The first singular wavelength-switching device 904 can switch the first set of wavelengths from the plurality of optical wavelength multiplexers 512 to the plurality of first optical interfaces 516. The second singular wavelength-switching device 906 can switch the second set of wavelengths from the plurality of second optical interfaces 518 to the plurality of optical wavelength demultiplexers 514.

The first singular wavelength-switching device 904 can include a plurality of M×N wavelength selective switches 610-1, 610-3, 610-5, 610-7, wherein each M×N wavelength selective switch comprises M input ports and N output ports, and wherein each M×N wavelength selective switch can switch the first set of wavelengths from the plurality of optical wavelength multiplexers 512 to the plurality of first optical interfaces 516.

The second singular wavelength-switching device 906 can include a plurality of K×L wavelength selective switches 610-2, 610-4, 610-6, 610-8, wherein each K×L wavelength selective switch comprises K input ports and L output ports, and wherein each K×L wavelength selective switch can switch the second set of wavelengths from the plurality of second optical interfaces 518 to the plurality of optical wavelength demultiplexers 514.

In some embodiments, and depicted in FIG. 9, M, N, K and L can be 2. In some embodiments, and not shown in FIG. 9, M, N, K can be 2 and L can be 1. For example, the K×L switches 610-2, 610-4, 610-6, and 610-8, which are 2×2 switches and have an “NC” port in FIG. 9, can be replaced by 2×1 switches.

Each M×N wavelength selective switch 610-1, 610-3, 610-5, 610-7 can further switch the first set of wavelengths from the plurality of optical wavelength multiplexers 512 to one K×L wavelength selective switch 610-2, 610-4, 610-6, 610-8. Each K×L wavelength selective switch can further switch the first set of wavelengths from one M×N wavelength selective switch to the plurality of optical wavelength demultiplexers 514.

The optical apparatus 900 can further comprise the amplified spontaneous emission (ASE) noise source 602 used to generate ASE noise. Each M×N wavelength selective switch 610-1, 610-3, 610-5, 610-7 can be capable of selectively substituting at least one wavelength of the first set of wavelengths with the ASE noise from the ASE noise source 602.

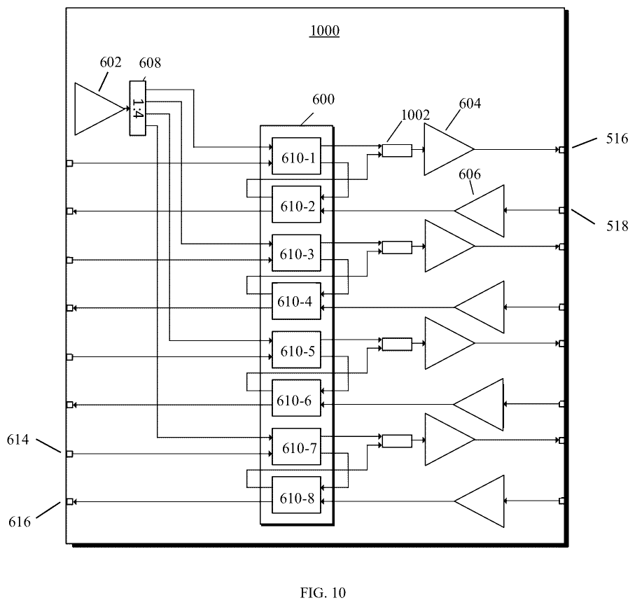

FIG. 10 depicts an OLT card 1000 that is substantially the same as the OLT card 508 depicted in FIG. 6, except that the unused outputs of the K×L WSS 610-2, 610-4, 610-6, 610-8 are used to loop back wavelengths from the plurality of second optical (line) interfaces 518 to the plurality of first optical (line) interfaces 516. The type of loopback depicted in FIG. 10 is referred to as a “line loopback”. To facilitate the line loopback, an optical element 1002 can be disposed prior to the output amplifier 604 to forward wavelengths from the M×N WSS 610-1, 610-3, 610-5, 610-7 the K×L WSS 610-2, 610-4, 610-6, 610-8 as depicted in FIG. 10. The optical element 1002 can be a 2×1 broadband optical switch. When using a 2×1 broadband optical switch for the optical element 1002, and the line loopback is performed, all the wavelengths from a given interface of the plurality of second optical line interfaces 518 can be simultaneously looped back to the corresponding interface of the first optical (line) interfaces 516. Using the line loopback can remove the need to replace any of the wavelengths with ASE noise from the ASE noise source 602 and remove the need to forward any of the wavelengths of the first set of wavelengths to the first optical (line) interfaces 516.

Alternatively, the optical element 1002 can be a 2:1 optical coupler. When using an optical coupler for optical element 1002, it's possible to loopback selective wavelengths, while forwarding other wavelengths from the multiplexer optical interface 614. For example, to loop back only wavelength number one from second optical (line) interface 518 to first optical (line) interface 516, while passing wavelengths numbers 2 to N from interface 614 to first optical (line) interface 516, WSS 610-1 would be configured to block wavelength number one to its switch output connected to optical element 1002 (e.g., the optical coupler) and to switch wavelengths 2 to N from multiplexer interface 614 to output connected to optical element 1002, while WSS 610-2 would be configured to switch only wavelength number one to its switch output connected to optical element 1002. The optical element 1002 (e.g., the optical coupler) would then combine the wavelength number one from 610-2 with wavelengths 2 to N from 610-1.

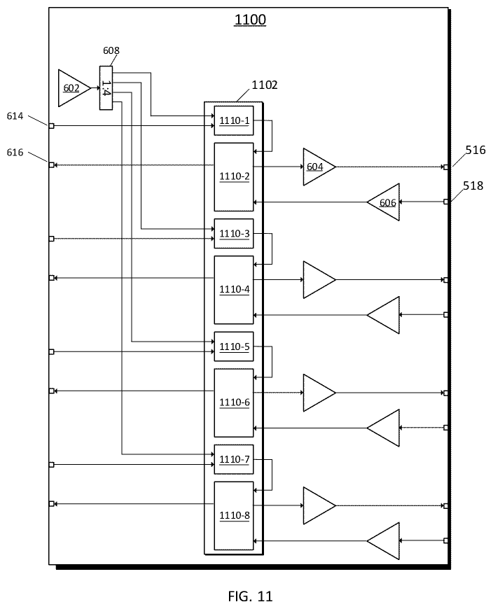

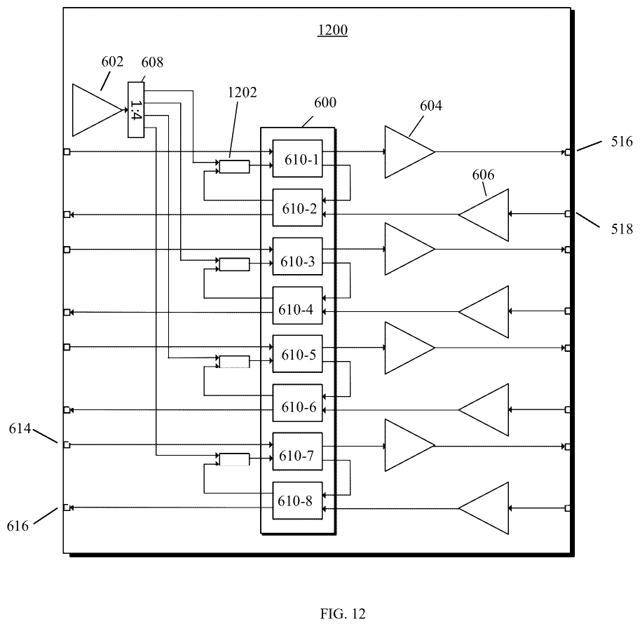

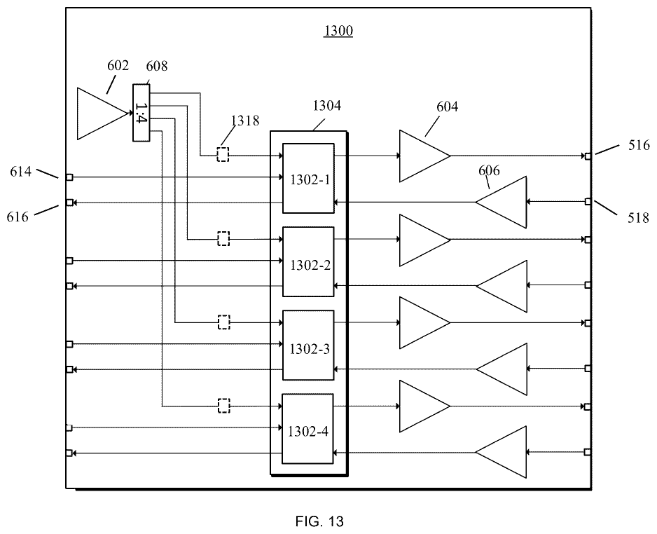

FIG. 11 depicts an OLT card 1100 that has similar functionality to the OLT card 508 depicted in FIG. 6, except replaces the singular wavelengths-switching device 600 with a singular wavelength-switching device 1102. The singular wavelength-switching device 1102 comprises M×N WSSs 1110-1, 1110-3, 1110-5, 110-7 and K×L WSS 1110-2, 1110-4, 1110-6, 1110-8. As depicted in FIG. 11, each M×N WSS is a 2×1 WSS, and each K×L WSS is a 2×2 WSS, (two inputs and two outputs, depicted in FIG. 11 as one output on one side and two inputs and one output on the opposite side). The outputs of M×N WSSs 1110-1, 1110-3, 1110-5, 1110-7 can be connected to one input of the K×L WSS 1110-2, 1110-4, 1110-6, 1110-8., The first optical (line) interface 516 can be connected to an output of K×L WSS 1110-2, 610-4, 1110-6, 1110-8. The second optical (line) interface 518 can be connected to an input of K×L WSS 1110-2, 1110-4, 1110-6, 1110-8, and the demultiplexer optical interface 616 can be connected to an output of K×L WSS 1110-2, 1110-4, 1110-6, 1110-8. The inputs of the M×N WSSs 1110-1, 1110-3, 1110-5, 1110-7 can be connected to the multiplexer optical interface 614 and the ASE noise source 602, respectively. The singular wavelength-switching device 1102 provides the means to: switch wavelengths from multiplexer optical interface 614 to the first optical (line) interface 516, and to switch wavelengths from the second optical (line) interface 518 to the demultiplexer optical interface 616, and to loop back wavelengths from the second optical (line) interface 518 to the first optical (line) interface 516, and to selectively substitute one or more wavelengths from multiplexer optical interface 614 with the ASE noise from the ASE noise source 602. The OLT card 1100 can be unique in that it requires no other optical components other than the singular wavelength-switching device 1102 to provide this functionality. Furthermore, the OLT card 1100 can be unique in that it simultaneously allows: some wavelengths to be switched from multiplexer optical interface 614 to the first optical (line) interface 516, some wavelengths from multiplexer optical interface 614 to be substituted with ASE noise and then switched to the first optical (line) interface 516, and some wavelengths to be looped back from the second optical (line) interface 518 to the first optical (line) interface 516. FIG. 12 depicts an OLT card 1200 which is substantially the same as the OLT card 508 depicted in FIG. 6, except that a 2×1 broadband optical switch 1202 is disposed prior to the second input of WSSs 610-1, 610-3, 610-5, 610-7 to either select ASE noise from the ASE noise source or wavelengths from K×L WSS 610-2, 610-4, 610-6, 610-8. as inputs to the M×N WSS 610-1, 610-3, 610-5, 610-7. The broadband optical switch 1202 provides a means to support line loop back. When this loopback is performed, all the wavelengths from a given interface 518 of the plurality of second optical (line) interfaces 516 can be simultaneously looped back to the corresponding interface 516 of the first optical (line) interfaces 516. Using the line loopback can remove the need to replace any of the wavelengths with ASE noise from the ASE noise source 602. FIG. 13 depicts an OLT card 1300 that performs substantially the same functionality as the OLT card 1000 depicted in FIG. 10. However, the OLT 1300 performs all wavelength switching and both multiplexer loopback and line loopback using 3×2 wavelength selective switches 1302-1 to 1302-4. The OLT card 1300 comprises a singular Multi 3×2 WSS device 1304, where the device 1304 includes N 3×2 WSS 1302 -1 to 1304-4, wherein N=4 in the OLT 1300 depicted in FIG. 13. Each of the 3×2 WSS 1302-1 to 1302-4 can be used to perform all the wavelength switching and loopbacks for one bidirectional optical rail 520-1, 520-2, 520-3, 520-4 (not depicted in FIG. 13).

In one embodiment, WSS 1302-1 can be used to describe wavelength switching within the OLT 1300. In normal mode of operation, wavelengths arriving at the multiplexer input interface 614 are switched from an input of WSS 1302-1 connected to the multiplexer input interface 614 to an output of WSS 1302-1 connected to the corresponding output amplifier 604. In the receive direction, wavelengths arriving on the optical line interface 518 are switched from an input of the WSS 1302-1 connected to an output of input amplifier 606 to an output of the WSS 1302-1 connected to the demultiplexer output interface 616.

When replacing a given wavelength arriving at the multiplexer input interface 614 with ASE noise from the ASE noise source 602, ASE noise from an input of the WSS 1302-1 connected to the 1:4 optical coupler 608 can be switched into the outgoing wavelength channel of the given wavelength of the signal exiting the output of the WSS 1302-1 connected to output amplifier 604.

Optionally, a VOA 1318 can be used to attenuate the ASE noise from 608. In multiplexer loopback mode, one or more wavelengths arriving at the multiplexer input interface 614 are switched from the input of the WSS 1302-1 connected to the multiplexer input interface 614 to the output of the WSS 1302-1 connected to the demultiplexer output interface 616.

In line loopback mode, one or more wavelengths arriving at the second optical (line) interface 518 are switched from the input of the WSS 1302-1 connected to the output of input amplifier 606 to the output of the WSS 1302-1 connected to the input of output amplifier 604.

In some embodiments (not shown in FIGS. 13), 1300 comprises a single 3×2 WSS in the singular WSS device 1304, a single output amplifier, and a single input amplifier, wherein the output of the ASE noise source 602 is connected to one input of the single 3×2 WSS.

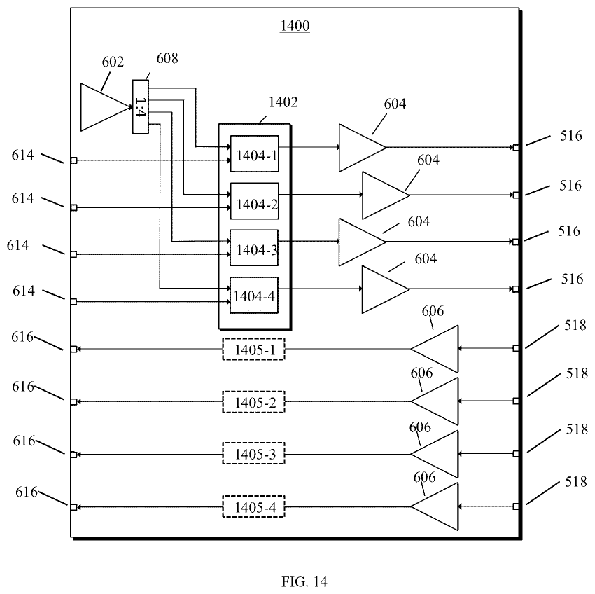

FIG. 14 depicts an OLT card 1400 that is substantially the same as the OLT card 508 depicted in FIG. 6, except that it does not support multiplexer input interface 614 to demultiplexer output interface 616 loopback (i.e., multiplexer loopback). For example, in OLT card 508 depicted in FIG. 6, an output of WSS 610-1 is connected to an input of WSS 610-2 to facilitate multiplexer loopback between the multiplexer input interface 614 and the demultiplexer output interface 616. In contrast, there is no such connectivity in a singular WSS device 1402 in the OLT card 1400. The singular wavelength-switching device 1402 requires half the number of WSS elements compared to the singular wavelength-switching device 600 of the OLT card 508. The device 1402 includes WSS 1404-1 to 1404-4, where N=4. Though N=4 as depicted in FIG. 14, N can be greater than 4 or less than 4. The WSS 1404-1 to 1404-4 can be 2×1 (as depicted in FIG. 14) where each WSS 1404-1 to 1404-4 has two inputs and 1 output, where one input can be connected to a given multiplexer input interface 614, the other input can be connected to the ASE noise source 602 via the optical coupler 608, and the output is connected to a given first optical line interface 516 via a given output amplifier 604. (However, the ASE noise source and ASE noise source optical distribution element 608 can be optionally omitted such that the singular wavelength-switching device 1402 becomes a plurality of 1×1 WSSs.). Because there is no multiplexer loopback, each second optical (line) interface 518 is directly connected to a demultiplexer output interface 616 via an input amplifier 606. Optionally, between each second optical (line) interface 518 and demultiplexer output interface 616, 1×1 WSS elements 1405-1 to 1405-4 can reside. The 1×1 WSS elements 1405-1 to 1405-4 can be part of the singular switching device 1402 (not depicted in FIG. 14), or in a separate singular switching device (also not depicted in FIG. 14), wherein WSS elements 1405-1 to 1405-4 can be used to block or attenuate wavelengths.

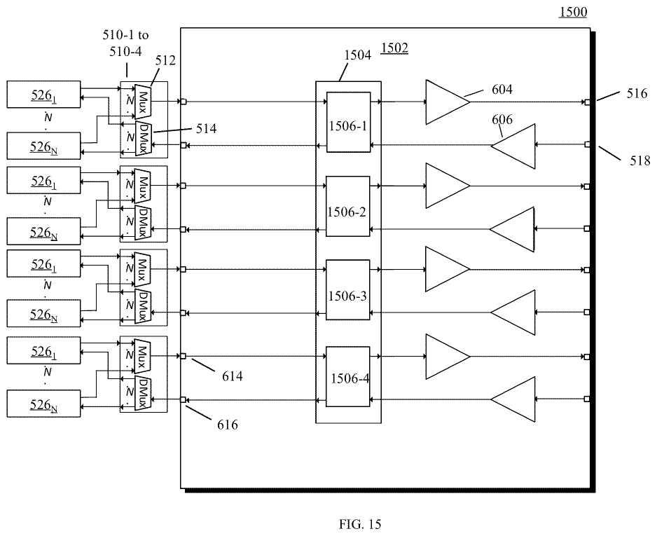

FIG. 15 an optical apparatus 1500 comprising an OLT card 1502 and the plurality of optical wavelength multiplexers 512 and the plurality of optical wavelength demultiplexers 514 (arranged in first sets 510-1 to 510-4). The OLT card 1502 does not support ASE noise fill and does not have an ASE noise source. The OLT 1502 can comprise a singular wavelength-switching device 1504 having 2×2 WSS 1506-1 to 1506-4. Each WSS 1506-1 to 1506-4 can switch wavelengths from a given multiplexer input interface 614 to either a corresponding demultiplexer output interface 616 (e.g., multiplexer loopback), or to a corresponding first optical line interface 516. Similarly, each WSS 1506-1 to 1506-4 can switch wavelengths from a given second optical line interface 518 to either a corresponding demultiplexer output interface 616 or a corresponding first optical line interface 518 (e.g., line loopback).

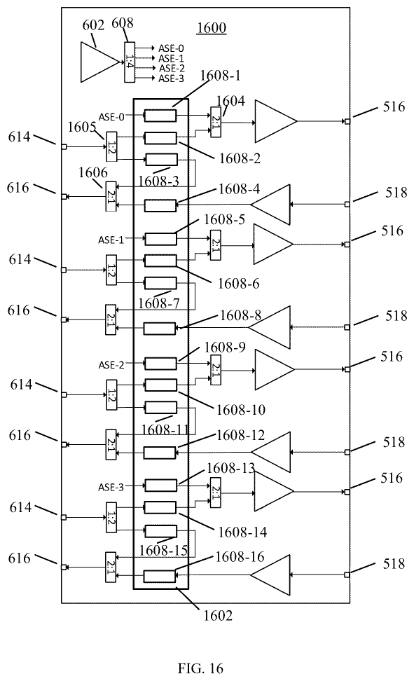

FIG. 16 depicts an OLT card 1600 that is substantially the same as the OLT card 508 depicted in FIG. 6, except that the functionality of the singular wavelength-switching device 600 depicted in FIG. 6 is implemented using a singular wavelength-switching device 1602 in combination with a plurality of optical couplers 1604, 1605, 1606. The singular wavelength-switching device 1602 comprises a plurality of 1×1 wavelength selective switches 1608-1 to 1608-16, where in combination with one of each optical coupler 1604, 1605, 1606 replace the functionality of, for example, WSS 610-1 and 610-2 depicted in FIG. 6. The 1×1 wavelength selective switches 1608-1 to 1608-16 can also be known as “wavelength blockers”. The singular wavelength-switching device 1602 can be used to switch a first set of wavelengths from the plurality of optical wavelength multiplexers 512 (not depicted in FIG. 16) connected to optical interfaces 614 to the plurality of first optical (line) interfaces 516 and a second set of wavelengths from the plurality of second optical (line) interfaces 518 to the plurality of optical wavelength demultiplexers 514 (not depicted in FIG. 16) connected to optical interfaces 616. As depicted in FIG. 16, a set of four 1×1 wavelength selective switches (e.g., WSS 1608-1 to 1608-4) can be used to switch a first set of wavelengths and a second set of wavelengths for a given rail 520-1, 520-2, 520-3, 520-4 (not shown in FIG. 16). Referring to WSS 1608-1 to 1608-4, WSS 1608-1 has an input to receive ASE noise from the ASE noise source 602 and an output coupled to one input of an optical coupler 1604. The optical coupler 1604 has two inputs and one output, where the output is coupled to a first optical line interface 516 via an optical amplifier 604. WSS 1608-2 has an input coupled to an output of an optical coupler 1605 and an output coupled to the other input of the optical coupler 1604. The optical coupler 1605 has one input and two outputs. The input of the optical coupler 1605 is coupled to a multiplexer input interface 614. WSS 1608-3 has one input coupled to the other output of the optical coupler 1605 and an output coupled to an input of an optical coupler 1606. The optical coupler 1606 has two inputs and one output, where the output is coupled to a demultiplexer output interface 616 and the other input is coupled to an output of WSS 1608-4. An input of WSS 1608-4 is coupled to a second optical (line) interface 518 via an input optical amplifier 606.

The singular wavelength-switching device 1602 can comprise a plurality of first 1×1 wavelength selective switches 1608-2, 1608-6, 1608-10, 1608-14 which can switch the first set of wavelengths from the plurality of optical wavelength multiplexers 512 to the plurality of first optical interfaces 516. The device 1602 can comprise a plurality of second 1×1 wavelength selective switches 1608-43, 1608-8, 1608-12, 1608-16 which can switch the second set of wavelengths from the plurality of second optical interfaces 518 to the plurality of optical wavelength demultiplexers 514 via optical interface 616.

The singular wavelength-switching device 1602 can comprise a plurality of third 1×1 wavelength selective switches 1608-3, 1608-7, 1608-11, 1608-15 which can switch the first set of wavelengths from the plurality of optical wavelength multiplexers 512 (connected to optical interfaces 614) to the plurality of optical wavelength demultiplexers 514 (connected to optical interfaces 616).

The singular wavelength-switching device 1602 can comprise a plurality of fourth 1×1 wavelength selective switches 1608-1, 1608-5, 1608-9, 1608-13, wherein each fourth 1×1 wavelength selective switch can be capable of selectively substituting at least one wavelength of the first set of wavelengths with the ASE noise from the ASE noise source 602. The optical apparatus 1600 can further comprise a plurality of first optical couplers 1605 disposed between the plurality of multiplexers 512 and the plurality of first 1×1 wavelength selective switches 1608-2, 1608-6, 1608-10, 1608-14 and the plurality of third 1×1 wavelength selective switches 1608-4, 1608-8, 1608-12, 1608-16. As depicted in FIG. 16, each first optical coupler 1605 can be a 1:2 optical coupler for receiving the first set of wavelengths from one multiplexer interface 614 and outputting the first set of wavelengths to a first 1×1 wavelength selective switch and a third 1×1 wavelength selective switch.

The optical apparatus 1600 can further comprise a plurality of second optical couplers 1606 disposed between the plurality of demultiplexers 514 (connected to optical interfaces 616) and the plurality of third 1×1 wavelength selective switches 1608-3, 1608-7, 1608-11, 1608-15 and the plurality of the plurality of second 1×1 wavelength selective switches 1608-4, 1608-8, 1608-12, 1608-16. The plurality of first optical couplers 1605 can provide the first set of wavelengths from the plurality of multiplexers 512 (connected to optical interfaces 614) to the plurality of first 1×1 wavelength selective switches 1608-2, 1608-6, 1608-10, 1608-14 and the plurality of third 1×1 wavelength selective switches 1608-3, 1608-7, 1608-11, 1608-15. The plurality of second optical couplers 1606 can provide the first set of wavelengths received from the plurality of third 1×1 wavelength selective switches 1608-3, 1608-7, 1608-11, 1608-15 and the second set of wavelengths received from the plurality of second 1×1 wavelength selective switches to the plurality of demultiplexers 514 via optical interface 616. As depicted in FIG. 16, the second optical couplers 1606 can be 2:1 optical couplers.

The optical apparatus 1600 can further comprise a plurality of third optical couplers 1604 disposed between the plurality of first optical interfaces 516 and the plurality of first 1×1 wavelength selective switches 1608-2, 1608-6, 1608-10, 1608-14 and the plurality of the plurality of fourth 1×1 wavelength selective switches 1608-1, 1608-5, 1608-9, 1608-13. The plurality of third optical couplers 1604 provides ASE noise received from the plurality of fourth 1×1 wavelength selective switches 1608-1, 1608-5, 1608-9, 1608-13 and the first set of wavelengths received from the plurality of first 1×1 wavelength selective switches 1608-2, 1608-6, 1608-10, 1608-14 to the plurality of first optical interfaces 516.

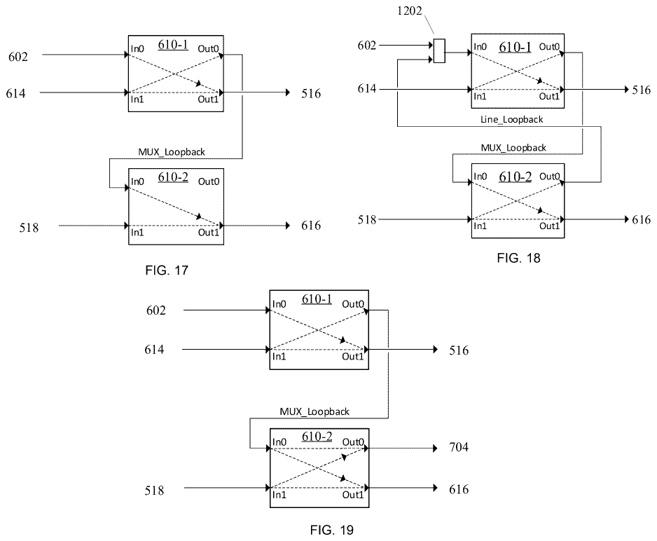

In some embodiments, not all optical paths are utilized through a given 2×2 wavelength selective switch. The number of paths utilized can depend upon the embodiment. FIG. 17, FIG. 18, and FIG. 19 depict optical paths utilized through a pair of 2×2 wavelength selective switches needed to switch the first set of wavelengths from the multiplexer (MuxIn) to the TxOut interface, and the second set of wavelengths from the RxIn interface to the demultiplexer output (DMuxOut).

FIG. 17 depicts utilized paths within a pair of 2×2 wavelength selective switches (e.g., WSS 610-1 and 610-2) that can be used in embodiments corresponding to FIG. 6, FIG. 8, and FIG. 9. In FIG. 17, input 602 corresponds to the input of 610-1 connected to the ASE source, wherein the ASE noise is only directed to the transmit optical line fiber interface 516, and not to the WSS 610-2. In FIG. 17, input 614 corresponds to the input of 610-1 connected to the multiplexer interface 614, wherein received wavelengths can be directed to either transmit optical line fiber interface 516 or to the WSS 610-2. FIG. 18 depicts utilized paths within a pair of 2×2 wavelength selective switches (e.g., WSS 610-1 and 610-2) that can be used in embodiments corresponding to FIG. 12. FIG. 18 is similar to FIG. 17, but there is an additional path used through 610-2 (from Out0) which is used to loop received line wavelengths back to the transmit optical line fiber. FIG. 19 depicts utilized paths within the pair of 2×2 wavelength selective switches (e.g., WSS 610-1 and 610-2) that can be used the embodiment corresponding to FIG. 7. FIG. 19 is similar to FIG. 17, but there are two additional paths used through WSS 610-2: the path from In0 to Out0 to route wavelengths from the multiplexer interface 614 to optical test port 704, and the path from In1 to Out0 to route wavelengths from the receive optical line interface 518 to optical test port 704. The upper 2×2 wavelength selective switch (e.g., WSS 610-1) of FIG. 17 can be described as a 2×1 wavelength selective switch in combination with a 1×2 wavelength selective switch, while the lower 2×2 wavelength selective switch of FIG. 17 can be described as a 2×1 wavelength selective switch. Similarly, the upper and lower 2×2 wavelength selective switches of FIG. 18 can each be described as a 2×1 wavelength selective switch in combination with a 1×2 wavelength selective switch. Lastly, the upper 2×2 wavelength selective switch of FIG. 19 can be described as a 2×1 wavelength selective switch in combination with a 1×2 wavelength selective switch, while the lower 2×2 wavelength selective switch of FIG. 19 can be described as a 2×2 wavelength selective switch.

For a given embodiment, since all paths through the WSSs may not be used, any calibration or testing of the unused paths would not be required, thereby simplifying the manufacturing process of the wavelength selective switch array. A wavelength selective switch where one or more paths through the switch are not used can be referred to as a “wavelength selective switch with limited paths”, or it can be referred to as a “wavelength selective switch with restricted paths”, or it can be referred to as a “wavelength selective switch with limited connectivity”, or it can be referred to as a “wavelength selective switch with restricted connectivity”, or it can be referred to as a “wavelength selective switch with reduced paths”, or it can be referred to as a “wavelength selective switch with reduced connectivity”, or it can be referred to as a “wavelength selective switch with reduced paths”, or it can be referred to as a “wavelength selective switch with restricted interconnect”, or it can be referred to as a “wavelength selective switch with restricted interconnectivity”. Similarly, a wavelength selective switch “array” where one or more paths through the switch array are not used can be referred to as a “wavelength selective switch array with limited paths”, or it can be referred to as a “wavelength selective switch array with restricted paths”, or it can be referred to as a “wavelength selective switch array with limited connectivity”, or it can be referred to as a “wavelength selective switch array with restricted connectivity”, or it can be referred to as a “wavelength selective switch array with reduced paths”, or it can be referred to as a “wavelength selective switch array with reduced connectivity”, or it can be referred to as a “wavelength selective switch array with restricted interconnect”, or it can be referred to as a “wavelength selective switch array with restricted interconnectivity”. The wavelength selective switch arrays of FIG. 4, FIG. 6, FIG. 10, FIG. 11, FIG. 8, and FIG. 9, all are “wavelength selective switch arrays with restrictive interconnectivity”, since at the very least, the path to send ASE noise to the demultiplexer interface is not used.

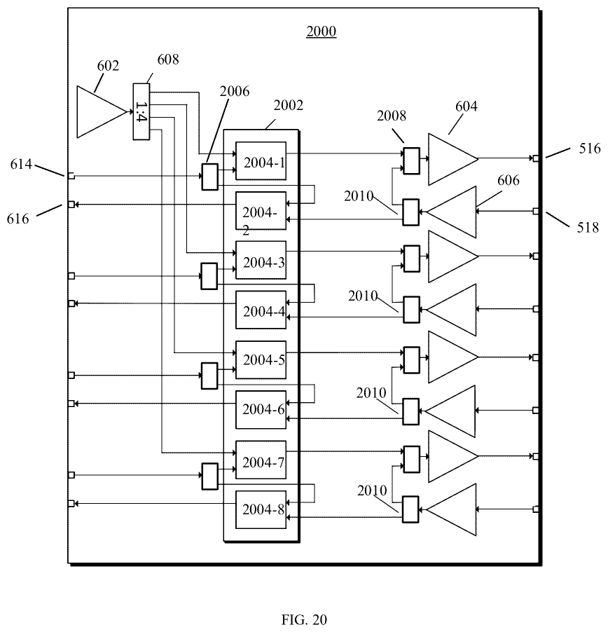

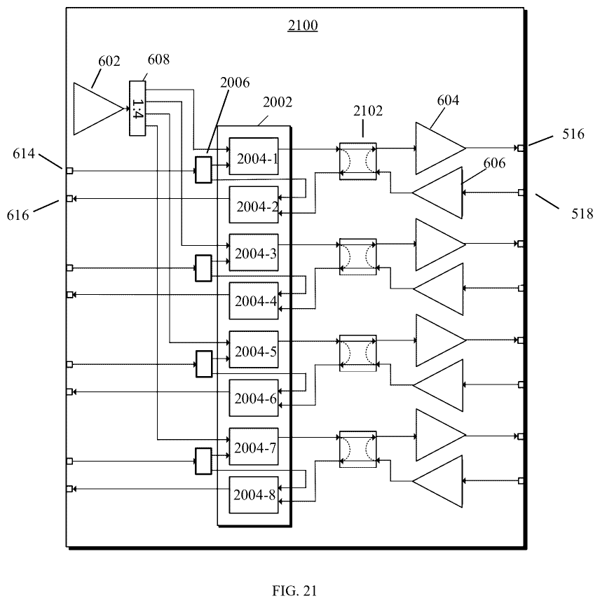

FIG. 20 and FIG. 21 depict optical line termination cards that are implemented solely with 2×1WSSs, thereby simplifying the singular wavelength-switching device utilized within the cards. Despite using only 2×1WSSs, both multiplexer loopback and line loopback functions can be provided as depicted in FIGS. 20 and 21.

FIG. 20 depicts an OLT card 2000 in accordance with some embodiments of the present disclosure. The OLT card 2000 includes a singular wavelength-switching device 2002, wherein the device 2002 includes 2×1 WSSs 2004-1 to 2004-8. The 2×1WSSs are arranged in pairs of two (e.g., WSS 2004-1 and WSS 2004-2) where an optical coupler 2006 is used to broadcast all the wavelengths received from the multiplexer input interface 614 to an input of both WSSs of the pair. This structure allows any wavelength from a wavelength multiplexer to either be looped back to the corresponding demultiplexer output interface 616 (e.g., via WSS 2004-2) or to be forwarded to the corresponding transmit optical line interface 516 (e.g., via WSS 2004-1). In addition, elements 2008 and 2010 of a WSS pair are used to enable the line loopback function. As depicted in FIG. 20, for each pair of WSSs (e.g., WSS 2004-1 and WSS 2004-2), the multiplexer input interface 614 is connected to the input of a 1-to-2 (1:2) optical coupler 2006. One output of the optical coupler 2006 is connected to the second input of the first WSS of a pair (e.g., WSS 2004-1) and the other output of the optical coupler is connected to the first input of the second WSS of a pair (e.g., WSS 2004-2) to facilitate loopback to the demultiplexer output interface 616. The output of the first WSS of a pair (e.g., WSS 2004-1) can connect to the first optical line interface 516 via element 2008 and an output amplifier 604. The element 2008 has two inputs and one output, where the output of the first WSS of a pair (e.g., WSS 2004-1) is connected to the first input of the element 2008 and the first output of element 2010 is connected to the second input of element 2008, while the output of the element 2008 is connected to the input of output amplifier 604, whose output is connected to the first optical (line) interface 516. The second optical (line) interface 518 can be connected to the second input of the second WSS of a pair (e.g., WSS 2004-2) via an input amplifier 606 and element 2010, and the second optical (line) interface 518 can be connected to the first optical (line) interface 516 via an input amplifier 606, element 2010, element 2008, and an output amplifier 604. The element 2010 has one input and two outputs, where the second optical line interface 518 can be connected to the input of the element 2010 (via an input amplifier 606), while one output of the element 2010 is connected to the second input of the second WSS of the pair (e.g., WSS 2004-2), and the other output of the element 2010 is connected to the second input of the element 2008.

As previously mentioned, the elements 2008 and 2010 are used in combination to implement the line loopback function. In some embodiments, the element 2008 can be a 2×1 broadband optical switch and the element 2010 can be a 1×2 broadband optical switch. For these embodiments, for normal operation, element 2008 (e.g., 2×1 broad band optical switch) can be configured to connect the output of the first WSS of a pair (e.g., WSS 2004-1) to the input of an output amplifier 604, and element 2010 (e.g., 1×2 broadband optical switch) can be configured to connect the output of an input amplifier 606 to the second input of the second WSS of a pair (e.g., WSS 2004-2). Conversely, for loopback operation, the element 2010 (e.g., 1×2 broadband optical switch) can be configured to connect the output of an input amplifier 606 to the second input of element 2008 (e.g., 2×1 broad band optical switch), and element 2008 can be configured to connect its second input to an output amplifier 604.

Alternatively, in some embodiments, the element 2008 can be a 2-to-1 optical coupler and the element 2010 can be a 1×2 broadband optical switch. For these embodiments, for normal operation, element 2010 (e.g., 1×2 broadband optical switch) is configured to connect the output of an input amplifier 606 to the second input of the second WSS of a pair (e.g., WSS 2004-2), and the first WSS of a pair (e.g., WSS 2004-1) forwards wavelengths to the element 2008 (e.g., 2-to-1 optical coupler). Conversely, for loopback operation, element 2010 (e.g., 1×2 broadband optical switch) can be configured to connect the output of an input amplifier 606 to the second input of the element 2008 (e.g., 2-to-1 optical coupler), and the first WSS of a pair (e.g., WSS 2004-1) is configured to block all wavelengths to the first input of element 2008 (e.g., 2-to-1 optical coupler). Alternatively, in some embodiments, the element 2008 can be a 2×1 broadband optical switch and the element 2010 can be a 1-to-2 optical coupler. For these embodiments, for normal operation, element 2008 (e.g., 2×1 broadband optical switch) is configured to connect the output of the first WSS of a pair (e.g., WSS 2004-1) to an output amplifier 604. Conversely, for loopback operation, element 2008 (e.g., 2×1 broadband optical switch) is configured to connect the first output of element 2010 (e.g., 1-to-2 optical coupler) to an output amplifier 604. Alternatively, the OLT card 2000 can be implemented without line loopback, wherein the output of the first 2×1 WSS of a pair (e.g., WSS 2004-1) directs a first set of wavelengths from the multiplexer input interface 614 to the first optical line interface 516 directly via the output amplifier 604, and wherein the output of the input amplifier 606 would direct the second set of wavelengths directly to the input of the second 2×1 WSS of a pair (e.g., WSS 2004-2) and then via the output thereof to the demultiplexer output interface 616. Alternatively, output and input amplifiers 604, 606 can be omitted from the OLT card 2000 (not shown in FIG. 20), and these amplifiers can be contained on one or more cards external to the OLT card 2000.

The 1-to-2 (1:2) optical coupler 2006 can be used to forward all wavelengths inputted to a given multiplexer input interface 514 to both the corresponding 2×1WSS (e.g., WSS 2004-1) (used to direct wavelengths to the corresponding first optical line interface 516) and the corresponding 2×1WSS (e.g., WSS 2004-2) (used to direct wavelengths to the corresponding demultiplexer output interface 616). This provides the means to either forward a given wavelength to a first optical line interface 516, or loopback the given wavelength to the associated optical transceiver (not shown in FIG. 20) via the demultiplexer output interface 616, or both simultaneously forward a given wavelength to the first optical line interface 516 and to the associated optical transceiver via the demultiplexer output interface 616. The 1-to-2 (1:2) optical coupler 2006 can have 50/50 coupling ratio or cannot have 50/50 coupling ratio. For example, the coupling ratio of the 1-to-2 (1:2) optical coupler 2006 can be such that substantially more light is directed to the first 2×1WSS of a pair (e.g., WSS 2004-1). Alternatively, the coupling ratio of the 1-to-2 (1:2) optical coupler 2006 can be such that substantially more light is directed to the second 2×1WSS of a pair (e.g., WSS 2004-2).

In some embodiments, wherein the element 2008 is a 2:1 optical coupler and the element 2010 is a 1×2 broadband optical switch, in line loopback mode, the wavelengths from the 2×1 WSS to the element 2008 (e.g., 2:1 optical coupler) are substantially attenuated by the WSS so as not to interfere with the wavelengths being looped back via the element 2010 (e.g., 1×2 broadband optical switch). The element 2008 (e.g., 2:1 optical coupler) can have a 50/50 coupling ratio or not have a 50/50 coupling ratio. For example, the coupling ratio of the element 2008 (e.g., 2:1 optical coupler) can be such that substantially more light is directed from the 2×1WSS to an output amplifier 604 than is directed from element 2010 (e.g., 1×2 broadband optical switch) to the output amplifier. Alternatively, the coupling ratio of the element 2008 (e.g., 2:1 optical coupler) can be such that substantially more light is directed from the element 2010 (e.g., 1×2broadband optical switch)to the output amplifier.

In some embodiments, wherein the element 2008 is a 2×1broadband optical switch and the element 2010 is a 1:2 optical coupler, the element 2010 (e.g., 1:2 optical coupler) can have a 50/50 coupling ratio or not have a 50/50 coupling ratio. For example, the coupling ratio of the element 2010 (e.g., 1:2 optical coupler) can be such that substantially more light is directed to the second 2×1WSS of a pair (e.g., WSS 2004-2) than is directed to element 2008 (e.g., 2×1 broadband optical switch). Alternatively, the coupling ratio of the element 2010 (e.g., 1:2 optical coupler) can be such that substantially more light is directed to the element 2008 (e.g., 2×1 broadband optical switch) than is directed to the WSS.

FIG. 21 depicts an OLT card 2100. The OLT card 2100 differs from the OLT card 2000 in that each pair of the elements 2008 and 2010 have been replaced by one 2×2 broadband optical switch 2102. Each 2×2 broadband optical switch 2102 can have a first switch setting and a second switch setting. When configured to the first switch setting the output of a given 2×1 WSS (e.g., WSS 2004-1) is connected to the input of a corresponding output amplifier 604, and the output of the corresponding input amplifier 606 is connected to a corresponding 2×1 WSS (e.g., WSS 2004-2). This first switch setting is depicted in FIG. 21 by solid lines through each 2×2 broadband optical switch 2102. When configured to the second switch setting the output of a given input amplifier 606 is connected to the input of a corresponding output amplifier 604, and the output of a given 2×1 WSS (e.g., WSS 2004-1 is connected to an input of a corresponding 2×1 WSS (e.g., WSS 2004-2). This second switch setting is depicted in FIG. 21 by dash lines through each 2×2 broadband optical switch 2102. Alternatively, when configured to the second switch setting the output of a given input amplifier 606 is connected to the input of a corresponding output amplifier 604, and the input of the given 2×1 WSS (e.g., WSS 2004-2) is unconnected (so that there is only one connection for the second switch setting).

In some embodiments of the present disclosure, an optical apparatus comprises a plurality of first optical interfaces; a plurality of second optical interfaces; a plurality of optical wavelength multiplexers operable to multiplex a first set of wavelengths from a plurality of optical transceivers; a plurality of optical wavelength demultiplexers operable to demultiplex a second set of wavelengths to the plurality of optical transceivers; and a singular wavelength-switching device operable to individually switch wavelengths of the first set of wavelengths from the plurality of optical wavelength multiplexers to the plurality of first optical interfaces and to the plurality of optical wavelength demultiplexers, and operable to individually switch wavelengths of the second set of wavelengths from the plurality of second optical interfaces to the plurality of optical wavelength demultiplexers.

The optical apparatus of the preceding paragraph, wherein the singular wavelength-switching device comprises a shared optical assembly.

The optical apparatus of any of the two preceding paragraphs, wherein the shared optical assembly comprises at least one selected from the group consisting of a shared optical lens, a shared diffraction grating, and a shared singular polarization modulation array, and combinations thereof.

The optical apparatus of any of the three preceding paragraphs, wherein the shared singular polarization modulation array comprises one selected from the group consisting of a liquid crystal cell array, a single liquid crystal on silicon (LOCS) chip, and a thin-film transistor liquid crystal panel.

The optical apparatus of any of the four preceding paragraphs, wherein the shared singular polarization modulation array comprises the liquid crystal cell array, and wherein the liquid crystal cell array comprises a plurality of pixel cells, wherein at least one of the plurality of pixel cells is operable to rotate or not rotate the polarization orientation of light incident thereon to switch at least one wavelength of the first set of wavelengths within the singular wavelength-switching device.

The optical apparatus of any of the five preceding paragraphs, wherein the shared singular polarization modulation array is operable to switch the first set of wavelengths and the second set of wavelengths within the singular wavelength-switching device.

The optical apparatus of any of the six preceding paragraphs, further comprising an amplified spontaneous emission (ASE) noise source operable to generate ASE noise, wherein the singular wavelength-switching device is capable of selectively substituting at least one wavelength of the first set of wavelengths with the ASE noise from the ASE noise source.

The optical apparatus of any of the seven preceding paragraphs, wherein the singular wavelength-switching device comprises a shared singular polarization modulation array, wherein the shared singular polarization modulation array is operable to individually switch wavelengths of the first set of wavelengths from the plurality of optical wavelength multiplexers to the plurality of first optical interfaces and to the plurality of optical wavelength demultiplexers, and wherein the shared singular polarization modulation array is operable to individually switch wavelengths of the second set of wavelengths from the plurality of second optical interfaces to the plurality of optical wavelength demultiplexers, and wherein the shared singular polarization modulation array is operable to substitute at least one wavelength of the first set of wavelengths with the ASE noise from the ASE noise source.

The optical apparatus of any of the eight preceding paragraphs, wherein the singular wavelength-switching device comprises a plurality of M×N wavelength selective switches and a plurality of K×L wavelength selective switches, wherein each M×N wavelength selective switch comprises M input ports and N output ports, wherein each K×L wavelength selective switch comprises K input ports and L output ports, wherein the plurality of M×N wavelength selective switches are operable to switch one or more wavelengths of the first set of wavelengths from the plurality of optical wavelength multiplexers to the plurality of first optical interfaces, and wherein the plurality of K×L wavelength selective switches are operable to switch one or more wavelengths of the second set of wavelengths from the plurality of second optical interfaces to the plurality of optical wavelength demultiplexers, and wherein the plurality of M×N wavelength selective switches are operable to selectively substituting one or more wavelengths of the first set of wavelengths with the ASE noise from the ASE noise source, and wherein the plurality of M×N wavelength selective switches are operable to switch one or more wavelengths of the first set of wavelengths from the plurality of optical wavelength multiplexers to the plurality of K×L wavelength selective switches, and wherein the plurality of K×L wavelength selective switches are operable to switch one or more wavelengths of the first set of wavelengths from the plurality of M×N wavelength selective switches to the plurality of optical wavelength demultiplexers.

The optical apparatus of any of the preceding nine paragraphs, wherein the plurality of M×N wavelength selective switches comprises a plurality of 2×2 wavelength selective switches, and wherein the plurality of K×L wavelength selective switches comprises at least one selected from the group consisting of a plurality of 2×1 wavelength selective switches and a plurality of 2×2 wavelength selective switches.

The optical apparatus of any of the preceding ten paragraph, further comprising a plurality of broadband optical switches, wherein the plurality of broadband optical switches are operable to forwarding wavelengths from the plurality of K×L wavelength selective switches to the plurality of M×N wavelength selective switches, and wherein the plurality of broadband optical switches are operable to forwarding the ASE noise from the ASE noise source to the plurality of M×N wavelength selective switches.

The optical apparatus of any of the preceding eleven paragraphs, wherein the plurality of M×N wavelength selective switches comprises a plurality of 2×2 wavelength selective switches, and wherein the plurality of K×L wavelength selective switches are a plurality of 2×2 wavelength selective switches.

The optical apparatus of any of the preceding twelve paragraphs, wherein the first set of wavelengths comprises a plurality of first bands, each first band of the plurality of first bands having a subset of the first set of wavelengths, and the second set of wavelengths comprises a plurality of second bands, each second band of the plurality of second bands having a subset of the second set of wavelengths, wherein at least one of the plurality of optical wavelength multiplexers is operable to multiplex wavelengths of at least one of the plurality of first bands, and at least one of the plurality of optical wavelength demultiplexers is operable to demultiplex wavelengths of at least one of the plurality of second bands, wherein at least one of the plurality of M×N wavelength selective switches is operable to switch one or more wavelengths of the at least one of the plurality of first bands from the at least one of the plurality of optical wavelength multiplexers to at least one of the plurality of first optical interfaces, and wherein at least one of the plurality of K×L wavelength selective switches is operable to switch one or more wavelengths of the at least one of the plurality of second bands from at least one of the plurality of second optical interfaces to at least one of the plurality of optical wavelength demultiplexers, and wherein the at least one of the plurality of M×N wavelength selective switches is operable to switch one or more wavelengths of the at least one of the plurality of first bands from the at least one of the plurality of optical wavelength multiplexers to the at least one of the plurality of K×L wavelength selective switches, and wherein the at least one of the plurality of K×L wavelength selective switches is operable to switch one or more wavelengths of the at least one of the plurality of first bands received from the at least one of the plurality of M×N wavelength selective switches to the at least one of the plurality of optical wavelength demultiplexers, and wherein the at least one of the plurality of M×N wavelength selective switches is operable to selectively substitute one or more wavelengths of the at least one of the plurality of first bands from the at least one of the plurality of optical wavelength multiplexers with the ASE noise from the ASE noise source.

The optical apparatus of any of the preceding thirteen paragraphs, wherein the at least one of the plurality of K×L wavelength selective switches is operable to switch wavelengths of the at least one of the plurality of second bands received from the at least one of the plurality of second optical interfaces to the at least one of the plurality of first optical interfaces.

The optical apparatus of any of the preceding fourteen, further comprising at least one optical coupler operable to couple wavelengths from the at least one of the plurality of M×N wavelength selective switches with wavelengths from the at least one of the plurality of K×L wavelength selective switches to the at least one of the plurality of first optical interfaces.

The optical apparatus of any of the preceding fifteen paragraphs, wherein the at least one of the plurality of K×L wavelength selective switches is operable to switch wavelengths of the at least one of the plurality of second bands received from the at least one of the plurality of second optical interfaces to the at least one of the plurality of M×N wavelength selective switches, and wherein the at least one of the plurality of M×N wavelength selective switches is operable to switch wavelengths of the at least one of the plurality of second bands received from the at least one of the plurality of K×L wavelength selective switches to the at least one of the plurality of first optical interfaces.

The optical apparatus of any of the preceding sixteen paragraphs, wherein the at least one of the plurality of M×N wavelength selective switches is operable to selectively substitute at least one wavelength of the at least one of the plurality of first bands with the ASE noise from the ASE noise source.

The optical apparatus of any of the preceding seventeen paragraphs, wherein the singular wavelength-switching device comprises a plurality of M×N wavelength selective switches and a plurality of K×L wavelength selective switches, wherein each M×N wavelength selective switch comprises M input ports and N output ports, wherein each K×L wavelength selective switch comprises K input ports and L output ports, wherein the plurality of M×N wavelength selective switches are operable to switch one or more wavelengths of the first set of wavelengths from the plurality of optical wavelength multiplexers to the plurality of first optical interfaces, and wherein the plurality of K×L wavelength selective switches are operable to switch one or more wavelengths of the second set of wavelengths from the plurality of second optical interfaces to the plurality of optical wavelength demultiplexers, and wherein the plurality of K×L wavelength selective switches are operable to switch one or more wavelengths of the first set of wavelengths to the plurality of optical wavelength demultiplexers.

The optical apparatus of any of the preceding eighteen paragraphs, wherein the first set of wavelengths comprises a plurality of first bands, wherein at least one of the plurality of optical wavelength multiplexers is operable to multiplex wavelengths of at least one of the plurality of first bands, and wherein at least one of the plurality of M×N wavelength selective switches is operable to switch wavelengths of the at least one of the plurality of first bands from the at least one of the plurality of optical wavelength multiplexers to at least one of the plurality of first optical interfaces.

The optical apparatus of any of the nineteen preceding paragraphs, wherein the second set of wavelengths comprises a plurality of second bands, wherein at least one of the plurality of second optical interfaces is operable to receive at least one of the plurality of second bands, and wherein at least one of the plurality of K×L wavelength selective switches is operable to switch wavelengths of the at least one of the plurality of second bands to at least one of the plurality of optical wavelength demultiplexers.

The optical apparatus of any of the twenty preceding paragraphs, wherein the at least one of the plurality of K×L wavelength selective switches is operable to switch the at least one of the plurality of first bands to the at least one of the plurality of optical wavelength demultiplexers.

The optical apparatus of any of the twenty one preceding paragraphs, further comprising an optical coupler operable to couple the at least one of the plurality of first bands to the at least one of the plurality of M×N wavelength selective switches and to the at least one of the plurality of K×L wavelength selective switches.

The optical apparatus of any of the twenty two preceding paragraphs, further comprising a first broadband optical switch and one selected from the group consisting of a second optical coupler and a second broadband optical switch operable to switch wavelengths of the at least one of the plurality of second bands to the at least one of the plurality of first optical interfaces.

The optical apparatus of any of the twenty three preceding paragraphs, further comprising a broadband optical switch operable to switch wavelengths of the at least one of the plurality of second bands to the at least one of the plurality of first optical interfaces and the at least one of the plurality of first bands to the at least one of the plurality of K×L wavelength selective switches.

The optical apparatus of any of the twenty four preceding paragraphs, wherein the at least one of the plurality of K×L wavelength selective switches is operable to switch wavelengths of the at least one of the plurality of second bands from the plurality of second optical interfaces to the at least one of the plurality of M×N wavelength selective switches, and wherein the at least one of the plurality of M×N wavelength selective switches is operable to switch wavelengths of the at least one of the plurality of second bands to the plurality of first optical interfaces.

The optical apparatus of any of the twenty five preceding paragraphs, wherein the at least one of the plurality of K×L wavelength selective switches is operable to switch wavelengths of the at least one of the plurality of second bands from the plurality of second optical interfaces to the plurality of first optical interfaces.

The optical apparatus of any of the twenty six preceding paragraphs, wherein the first set of wavelengths comprises a plurality of first bands, each band of the plurality of first bands having a subset of the first set of wavelengths, and wherein the second set of wavelengths comprises a plurality of second bands, each band of the plurality of second bands having a subset of the second set of wavelengths, and wherein the singular wavelength-switching device comprises a plurality of M×N wavelength selective switches having M input ports and N output ports, and wherein at least one of the plurality of M×N wavelength selective switches is operable to switch one or more wavelengths of at least one of the plurality of first bands from at least one of the plurality of optical wavelength multiplexers to at least one of the plurality of first optical interfaces, and wherein the at least one of the plurality of M×N wavelength selective switches is operable to switch one or more wavelengths of at least one of the plurality of second bands from at least one of the plurality of second optical interfaces to at least one of the plurality of optical wavelength demultiplexers.

The optical apparatus of any of the twenty seven preceding paragraphs, wherein the at least one of the plurality of M×N wavelength selective switches is operable to switch one or more wavelengths of the at least one of the plurality of first bands from the at least one of the plurality of optical wavelength multiplexers to the at least one of the plurality of optical wavelength demultiplexers, and wherein the at least one of the plurality of M×N wavelength selective switches is operable to switch one or more wavelengths of the at least one of the plurality of second bands from the at least one of the plurality of second optical interfaces to the at least one of the plurality of first optical interfaces.

The optical apparatus of any of the twenty eight preceding paragraphs, wherein M and N are 2.

The optical apparatus of any of the twenty nine preceding paragraphs, wherein M is greater than 2 and N is 2.

The optical apparatus of any of the thirty preceding paragraphs, further comprising an amplified spontaneous emission (ASE) noise source used to generate ASE noise, wherein the at least one of the plurality of M×N wavelength selective switches is operable to substitute at least one wavelength of the plurality of first bands with the ASE noise from the ASE noise source.

The optical apparatus of any of the thirty one preceding paragraphs, wherein M is 3 and N is 2.

The optical apparatus of any of the thirty two preceding paragraphs, wherein the singular wavelength-switching device comprises a plurality of first 1×1 wavelength selective switches operable to switch wavelengths the first set of wavelengths from the plurality of optical wavelength multiplexers to the plurality of first optical interfaces and a plurality of second 1×1 wavelength selective switches operable to switch wavelengths of the second set of wavelengths from the plurality of second optical interfaces to the plurality of optical wavelength demultiplexers.

The optical apparatus of any of the thirty three preceding paragraphs, wherein the singular wavelength-switching device further comprises a plurality of third 1×1 wavelength selective switches operable to switch wavelengths of the first set of wavelengths from the plurality of optical wavelength multiplexers to the plurality of optical wavelength demultiplexers.

The optical apparatus of any of the thirty four preceding paragraphs, further comprising an amplified spontaneous emission (ASE) noise source used to generate ASE noise, and wherein the singular wavelength-switching device further comprises a plurality of fourth 1×1 wavelength selective switches operable to substitute at least one wavelength of the first set of wavelengths with the ASE noise from the ASE noise source.

The optical apparatus of any of the thirty five preceding paragraphs, further comprising a plurality of first optical couplers operable to forward the first set of wavelengths from the plurality of optical wavelength multiplexers to the plurality of first 1×1 wavelength selective switches and the plurality of third 1×1 wavelength selective switches; a plurality of second optical couplers operable to couple wavelengths from the plurality of third 1×1 wavelength selective switches and wavelengths from the plurality of second 1×1 wavelength selective switches to the plurality of optical wavelength demultiplexers; a singular optical coupler used to forward the ASE noise from the ASE noise source to the plurality of fourth 1×1 wavelength selective switches; and a plurality of third optical couplers operable to couple the ASE noise from the plurality of fourth 1×1 wavelength selective switches with the wavelengths from the plurality of first 1×1 wavelength selective switches.

The optical apparatus of any of the thirty six preceding paragraphs, further comprising a circuit card, wherein the circuit card comprises the plurality of first optical interfaces, the plurality of second optical interfaces, and the singular wavelength-switching device, and wherein the plurality of optical wavelength multiplexers and the plurality of optical wavelength demultiplexers are located externally to the circuit card.

The optical apparatus of any of the thirty seven preceding paragraphs, wherein the plurality of optical wavelength multiplexers and the plurality of optical wavelength demultiplexers comprises one selected from the group consisting of arrayed waveguide gratings, optical couplers, wavelength selective switches, and a plurality of interference filters, each interference filter allowing at least one wavelength to pass through while reflecting remaining wavelengths.

In some embodiments of the present disclosure an optical apparatus comprises a plurality of first optical interfaces; a plurality of second optical interfaces; a plurality of optical wavelength multiplexers operable to multiplex a plurality of first wavelengths from a plurality of optical transceivers; a plurality of optical wavelength demultiplexers operable to demultiplex a plurality of second wavelengths to the plurality of optical transceivers; a first singular wavelength-switching device; and a second singular wavelength-switching device, wherein in combination the first singular wavelength-switching device and the second singular wavelength-switching device are operable to individually switch wavelengths of the plurality of first wavelengths from the plurality of optical wavelength multiplexers to the plurality of first optical interfaces and to the plurality of optical wavelength demultiplexers, and operable to individually switch wavelengths of the plurality of second wavelengths from the plurality of second optical interfaces to the plurality of optical wavelength demultiplexers.

The optical apparatus of the preceding paragraph, wherein the first singular wavelength-switching device is operable to individually switch wavelengths of a first set of the plurality of first wavelengths from a first set of the plurality of optical wavelength multiplexers to a first set of the plurality of first optical interfaces and to a first set of the plurality of optical wavelength demultiplexers, and operable to individually switch wavelengths of a first set of the plurality of second wavelengths from a first set of the plurality of second optical interfaces to the first set of the plurality of optical wavelength demultiplexers, and wherein the second singular wavelength-switching device is operable to individually switch wavelengths of a second set of the plurality of first wavelengths from a second set of the plurality of optical wavelength multiplexers to a second set of the plurality of first optical interfaces and to a second set of the plurality of optical wavelength demultiplexers, and operable to individually switch wavelengths of a second set of the plurality of second wavelengths from a second set of the plurality of second optical interfaces to the second set of the plurality of optical wavelength demultiplexers.

The optical apparatus of any of the two preceding paragraphs, wherein the first singular wavelength-switching device is operable to individually switch wavelengths of the plurality of first wavelengths from the plurality of optical wavelength multiplexers to the second singular wavelength-switching device and to the plurality of first optical interfaces, and wherein the second singular wavelength-switching device is operable to individually switch wavelengths of the plurality of second wavelengths from the plurality of second optical interfaces to the plurality of optical wavelength demultiplexers, and, wherein the second singular wavelength-switching device is operable to individually switch wavelengths from the first singular wavelength-switching device to the plurality of optical wavelength demultiplexers.

The optical apparatus of any of the three preceding paragraphs, wherein the first singular wavelength-switching device and the second singular wavelength-switching device comprise a plurality of M×N wavelength selective switches having M input ports and N output ports, and a plurality of K×L wavelength selective switches having K input ports and L output ports, and wherein the plurality of first wavelengths comprises a plurality of first bands of first wavelengths and a plurality of second bands of first wavelengths, and wherein the plurality of second wavelengths comprises a plurality of first bands of second wavelengths and a plurality of second bands of second wavelengths, wherein, in the first singular wavelength-switching device, at least one of the plurality of M×N wavelength selective switches is operable to switch wavelengths of at least one of the plurality of first bands of first wavelengths from at least one of the plurality of optical wavelength multiplexers to at least one of the plurality of first optical interfaces, and wherein at least one of the plurality of K×L wavelength selective switches is operable to switch wavelengths of at least one of the plurality of first bands of second wavelengths from at least one of the plurality of second optical interfaces to at least one of the plurality of optical wavelength demultiplexers, and wherein the at least one of the plurality of M×N wavelength selective switches is operable to switch wavelengths of the at least one of the plurality of first bands of first wavelengths from the at least one of the plurality of optical wavelength multiplexers to the at least one of the plurality of K×L wavelength selective switches, and wherein the at least one of the plurality of K×L wavelength selective switches is operable to switch wavelengths from the at least one of the plurality of M×N wavelength selective switches to the at least one of the plurality of optical wavelength demultiplexers, and wherein, in the at least a second singular wavelength-switching device, at least one of the plurality of M×N wavelength selective switches is operable to switch wavelengths of at least one of the at least a plurality of second bands of first wavelengths from at least one of the plurality of optical wavelength multiplexers to at least one of the plurality of first optical interfaces, and wherein at least one of the plurality of K×L wavelength selective switches is operable to switch wavelengths of at least one of the at least a plurality of second bands of second wavelengths from at least one of the plurality of second optical interfaces to at least one of the plurality of optical wavelength demultiplexers, and wherein the at least one of the plurality of M×N wavelength selective switches is operable to switch wavelengths of the at least one of the at least a plurality of second bands of first wavelengths from the at least one of the plurality of optical wavelength multiplexers to the at least one of the plurality of K×L wavelength selective switches, and wherein the at least one of the plurality of K×L wavelength selective switches is operable to switch wavelengths from the at least one of the plurality of M×N wavelength selective switches to the at least one of the plurality of optical wavelength demultiplexers.

The optical apparatus of any of the four preceding paragraphs, wherein, in the first singular wavelength-switching device, M is equal to 1, N is equal to 2, K is equal to 2, and L is equal to 1, and wherein, in the second singular wavelength-switching device, M is equal to 1, N is equal to 2, K is equal to 2, and L is equal to 1.

The optical apparatus of any of the five preceding paragraphs, further comprising an amplified spontaneous emission (ASE) noise source used to generate ASE noise, wherein, in the first singular wavelength-switching device, the at least one of the plurality of M×N wavelength selective switches is operable to selectively substitute at least one wavelength of the at least one of the plurality of first bands of first wavelengths with the ASE noise from the ASE noise source, and wherein, in the at least a second singular wavelength-switching device, the at least one of the plurality of M×N wavelength selective switches is operable to selectively substitute at least one wavelength of the at least one of the plurality of second bands of first wavelengths with the ASE noise from the ASE noise source.

The optical apparatus of any of the six preceding paragraphs, wherein the first singular wavelength-switching device comprises a plurality of M×N wavelength selective switches having M input ports and N output ports, and wherein the second singular wavelength-switching device comprises a plurality of K×L wavelength selective switches having K input ports and L output ports.

The optical apparatus of any of the seven preceding paragraphs, wherein M is equal to 1, N is equal to 2, K is equal to 2, and L is equal to 1.

The optical apparatus of any of the eight preceding paragraphs, further comprising an amplified spontaneous emission (ASE) noise source operable to generate ASE noise, wherein the first singular wavelength-switching device is operable to selectively substitute at least one wavelength of the plurality of first wavelengths with the ASE noise from the ASE noise source.

The optical apparatus of any of the nine preceding paragraphs, wherein the first singular wavelength-switching device comprises a plurality of M×N wavelength selective switches having M input ports and N output ports, and wherein the second singular wavelength-switching device comprises a plurality of K×L wavelength selective switches having K input ports and L output ports.

The optical apparatus of any of the ten preceding paragraphs, wherein M is equal to 2, N is equal to 2, K is equal to 2, and L is equal to 1.

In some embodiments of the present disclosure, an optical apparatus comprises a plurality of first optical interfaces; a plurality of optical wavelength multiplexers operable to multiplex a plurality of first wavelengths from a plurality of optical transceivers; and a singular wavelength-switching device operable to individually switch wavelengths of the plurality of first wavelengths from the plurality of optical wavelength multiplexers to the plurality of first optical interfaces.

The optical apparatus of the preceding paragraph, wherein the singular wavelength-switching device comprises a shared optical assembly, wherein the shared optical assembly comprises at least one selected from the group consisting of a shared optical lens, a shared diffraction grating, and a shared singular polarization modulation array, and combinations thereof, wherein the shared singular polarization modulation array comprises one selected from the group consisting of a liquid crystal cell array, a single liquid crystal on silicon (LOCS) chip, and a thin-film transistor liquid crystal panel, and to the plurality of first optical interfaces, wherein the liquid crystal cell array comprises a plurality of pixel cells, wherein at least one of the plurality of pixel cells is operable to rotate or not rotate the polarization orientation of light incident thereon to switch at least one wavelength of the plurality of first wavelengths within the singular wavelength-switching device.

The optical apparatus of any of the two preceding paragraphs, further comprising an amplified spontaneous emission (ASE) noise source operable to generate ASE noise, wherein the singular wavelength-switching device is operable to selectively substitute at least one wavelength of the plurality of first wavelengths with the ASE noise from the ASE noise source.

The optical apparatus of any of the three preceding paragraphs, further comprising a plurality of second optical interfaces; and a plurality of optical wavelength demultiplexers operable to demultiplex a plurality of second wavelengths to the plurality of optical transceivers, wherein the singular wavelength-switching device is operable to individually switch wavelengths of the plurality of second wavelengths from the plurality of second optical interfaces to the plurality of optical wavelength demultiplexers.

The optical apparatus of any of the four preceding paragraphs, wherein the singular wavelength-switching device comprises a plurality of M×N wavelength selective switches, wherein each M×N wavelength selective switch comprises M input ports and N output ports, wherein the plurality of M×N wavelength selective switches are operable to switch one or more wavelengths of the plurality of first wavelengths from the plurality of optical wavelength multiplexers to the plurality of first optical interfaces and to the plurality of optical wavelength demultiplexers, and wherein the plurality of M×N wavelength selective switches are operable to switch one or more wavelengths of the plurality of second wavelengths from the plurality of second optical interfaces to the plurality of optical wavelength demultiplexers and to the plurality of first optical interfaces.

The optical apparatus of any of the five preceding paragraphs, wherein M is equal to 2 and N is equal to 2.

The optical apparatus of any of the six preceding paragraphs, further comprising an amplified spontaneous emission (ASE) noise source operable to generate ASE noise, wherein the plurality of M×N wavelength selective switches are operable to selectively substitute wavelengths of the plurality of first wavelengths with the ASE noise from the ASE noise source.

The optical apparatus of any of the seven preceding paragraphs, wherein M is equal to 3 and N is equal to 2.

While this specification contains many specific implementation details, these should not be construed as limitations on the scope of any disclosure or of what can be claimed, but rather as descriptions of features that can be specific to particular embodiments of particular disclosures. Certain features that are described in this specification in the context of separate embodiments can also be implemented in combination in a single embodiment. Conversely, various features that are described in the context of a single embodiment can also be implemented in multiple embodiments separately or in any suitable sub combination. Moreover, although features can be described above as acting in certain combinations and even initially claimed as such, one or more features from a claimed combination can in some cases be excised from the combination, and the claimed combination can be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products. Particular embodiments of the subject matter have been described. Other embodiments are within the scope of the following claims.

What is claimed is:

1. An optical apparatus, comprising:
a plurality of first optical interfaces;
a plurality of second optical interfaces;
a plurality of optical wavelength multiplexers operable to multiplex a first set of wavelengths from a plurality of optical transceivers;
a plurality of optical wavelength demultiplexers operable to demultiplex a second set of wavelengths to the plurality of optical transceivers; and
a singular wavelength-switching device operable to individually switch wavelengths of the first set of wavelengths from the plurality of optical wavelength multiplexers to the plurality of first optical interfaces and to the plurality of optical wavelength demultiplexers, and operable to individually switch wavelengths of the second set of wavelengths from the plurality of second optical interfaces to the plurality of optical wavelength demultiplexers.

2. The optical apparatus of claim 1, wherein the singular wavelength-switching device comprises a shared optical assembly,
wherein the shared optical assembly comprises at least one selected from the group consisting of a shared optical lens, a shared diffraction grating, and a shared singular polarization modulation array, and combinations thereof,
wherein the shared singular polarization modulation array comprises one selected from the group consisting of a liquid crystal cell array, a single liquid crystal on silicon (LOCS) chip, and a thin-film transistor liquid crystal panel, and
wherein the liquid crystal cell array comprises a plurality of pixel cells, and wherein at least one of the plurality of pixel cells is operable to rotate or not rotate the polarization orientation of light incident thereon to switch at least one wavelength of the first set of wavelengths within the singular wavelength-switching device.

3. The optical apparatus of claim 1, further comprising an amplified spontaneous emission (ASE) noise source operable to generate ASE noise,
wherein the singular wavelength-switching device is capable of selectively substituting one or more wavelengths of the first set of wavelengths with the ASE noise from the ASE noise source.

4. The optical apparatus of claim 3, wherein the singular wavelength-switching device comprises a shared singular polarization modulation array,
wherein the shared singular polarization modulation array is operable to individually switch wavelengths of the first set of wavelengths from the plurality of optical wavelength multiplexers to the plurality of first optical interfaces and to the plurality of optical wavelength demultiplexers, and
wherein the shared singular polarization modulation array is operable to individually switch wavelengths of the second set of wavelengths from the plurality of second optical interfaces to the plurality of optical wavelength demultiplexers, and
wherein the shared singular polarization modulation array is operable to substitute at least one wavelength of the first set of wavelengths with the ASE noise from the ASE noise source.

5. The optical apparatus of claim 3, wherein the singular wavelength-switching device comprises a plurality of M×N wavelength selective switches and a plurality of K×L wavelength selective switches,
wherein each M×N wavelength selective switch comprises M input ports and N output ports,
wherein each K×L wavelength selective switch comprises K input ports and L output ports,
wherein the plurality of M×N wavelength selective switches are operable to switch one or more wavelengths of the first set of wavelengths from the plurality of optical wavelength multiplexers to the plurality of first optical interfaces, and
wherein the plurality of K×L wavelength selective switches are operable to switch one or more wavelengths of the second set of wavelengths from the plurality of second optical interfaces to the plurality of optical wavelength demultiplexers, and
wherein the plurality of M×N wavelength selective switches are operable to selectively substituting one or more wavelengths of the first set of wavelengths with the ASE noise from the ASE noise source, and
wherein the plurality of M×N wavelength selective switches are operable to switch one or more wavelengths of the first set of wavelengths from the plurality of optical wavelength multiplexers to the plurality of K×L wavelength selective switches, and wherein the plurality of K×L wavelength selective switches are operable to switch one or more wavelengths of the first set of wavelengths from the plurality of M×N wavelength selective switches to the plurality of optical wavelength demultiplexers.

6. The optical apparatus of claim 5, wherein the plurality of M×N wavelength selective switches comprise a plurality of 2×2 wavelength selective switches, and wherein the plurality of K×L wavelength selective switches comprise at least one selected from the group consisting of a plurality of 2×1 wavelength selective switches and a plurality of 2×2 wavelength selective switches.

7. The optical apparatus of claim 5, further comprising:
a plurality of broadband optical switches,
wherein the plurality of broadband optical switches are operable to forwarding wavelengths from the plurality of K×L wavelength selective switches to the plurality of M×N wavelength selective switches, and
wherein the plurality of broadband optical switches are operable to forwarding the ASE noise from the ASE noise source to the plurality of M×N wavelength selective switches.

8. The optical apparatus of claim 7, wherein the plurality of M×N wavelength selective switches comprise a plurality of 2×2 wavelength selective switches, and wherein the plurality of K×L wavelength selective switches comprise a plurality of 2×2 wavelength selective switches.

9. The optical apparatus of claim 5, wherein the first set of wavelengths comprises a plurality of first bands, each first band of the plurality of first bands having a subset of the first set of wavelengths, and the second set of wavelengths comprises a plurality of second bands, each second band of the plurality of second bands having a subset of the second set of wavelengths,
wherein at least one of the plurality of optical wavelength multiplexers is operable to multiplex wavelengths of at least one of the plurality of first bands, and at least one of the plurality of optical wavelength demultiplexers is operable to demultiplex wavelengths of at least one of the plurality of second bands,
wherein at least one of the plurality of M×N wavelength selective switches is operable to switch one or more wavelengths of the at least one of the plurality of first bands from the at least one of the plurality of optical wavelength multiplexers to at least one of the plurality of first optical interfaces, and
wherein at least one of the plurality of K×L wavelength selective switches is operable to switch one or more wavelengths of the at least one of the plurality of second bands from at least one of the plurality of second optical interfaces to at least one of the plurality of optical wavelength demultiplexers, and.
wherein the at least one of the plurality of M×N wavelength selective switches is operable to switch one or more wavelengths of the at least one of the plurality of first bands from the at least one of the plurality of optical wavelength multiplexers to the at least one of the plurality of K×L wavelength selective switches, and
wherein the at least one of the plurality of K×L wavelength selective switches is operable to switch one or more wavelengths of the at least one of the plurality of first bands received from the at least one of the plurality of M×N wavelength selective switches to the at least one of the plurality of optical wavelength demultiplexers, and
wherein the at least one of the plurality of M×N wavelength selective switches is operable to selectively substitute one or more wavelengths of the at least one of the plurality of first bands from the at least one of the plurality of optical wavelength multiplexers with the ASE noise from the ASE noise source.

10. The optical apparatus of claim 1, wherein the first set of wavelengths comprises a plurality of first bands, each band of the plurality of first bands having a subset of the first set of wavelengths, and
wherein the second set of wavelengths comprises a plurality of second bands, each band of the plurality of second bands having a subset of the second set of wavelengths, and
wherein the singular wavelength-switching device comprises a plurality of M×N wavelength selective switches having M input ports and N output ports, and
wherein at least one of the plurality of M×N wavelength selective switches is operable to switch one or more wavelengths of at least one of the plurality of first bands from at least one of the plurality of optical wavelength multiplexers to at least one of the plurality of first optical interfaces, and
wherein the at least one of the plurality of M×N wavelength selective switches is operable to switch one or more wavelengths of at least one of the plurality of second bands from at least one of the plurality of second optical interfaces to at least one of the plurality of optical wavelength demultiplexers.

11. The optical apparatus of claim 10, wherein the at least one of the plurality of M×N wavelength selective switches is operable to switch one or more wavelengths of the at least one of the plurality of first bands from the at least one of the plurality of optical wavelength multiplexers to the at least one of the plurality of optical wavelength demultiplexers, and
wherein the at least one of the plurality of M×N wavelength selective switches is operable to switch one or more wavelengths of the at least one of the plurality of second bands from the at least one of the plurality of second optical interfaces to the at least one of the plurality of first optical interfaces.

12. An optical apparatus, comprising:
a plurality of first optical interfaces;
a plurality of second optical interfaces;
a plurality of optical wavelength multiplexers operable to multiplex a plurality of first wavelengths from a plurality of optical transceivers;
a plurality of optical wavelength demultiplexers operable to demultiplex a plurality of second wavelengths to the plurality of optical transceivers;
a first singular wavelength-switching device; and
a second singular wavelength-switching device,
wherein in combination the first singular wavelength-switching device and the second singular wavelength-switching device are operable to individually switch wavelengths of the plurality of first wavelengths from the plurality of optical wavelength multiplexers to the plurality of first optical interfaces and to the plurality of optical wavelength demultiplexers, and operable to individually switch wavelengths of the plurality of second wavelengths from the plurality of second optical interfaces to the plurality of optical wavelength demultiplexers.

13. The optical apparatus of claim 12, wherein the first singular wavelength-switching device is operable to individually switch wavelengths of a first set of the plurality of first wavelengths from a first set of the plurality of optical wavelength multiplexers to a first set of the plurality of first optical interfaces and to a first set of the plurality of optical wavelength demultiplexers, and operable to individually switch wavelengths of a first set of the plurality of second wavelengths from a first set of the plurality of second optical interfaces to the first set of the plurality of optical wavelength demultiplexers, and
wherein the second singular wavelength-switching device is operable to individually switch wavelengths of a second set of the plurality of first wavelengths from a second set of the plurality of optical wavelength multiplexers to a second set of the plurality of first optical interfaces and to a second set of the plurality of optical wavelength demultiplexers, and operable to individually switch wavelengths of a second set of the plurality of second wavelengths from a second set of the plurality of second optical interfaces to the second set of the plurality of optical wavelength demultiplexers.

14. The optical apparatus of claim 12, wherein the first singular wavelength-switching device is operable to individually switch wavelengths of the plurality of first wavelengths from the plurality of optical wavelength multiplexers to the second singular wavelength-switching device and to the plurality of first optical interfaces, and
wherein the second singular wavelength-switching device is operable to individually switch wavelengths of the plurality of second wavelengths from the plurality of second optical interfaces to the plurality of optical wavelength demultiplexers, and,
wherein the second singular wavelength-switching device is operable to individually switch wavelengths from the first singular wavelength-switching device to the plurality of optical wavelength demultiplexers.

15. An optical apparatus, comprising:
a plurality of first optical interfaces;
a plurality of optical wavelength multiplexers operable to multiplex a plurality of first wavelengths from a plurality of optical transceivers; and
a singular wavelength-switching device operable to individually switch wavelengths of the plurality of first wavelengths from the plurality of optical wavelength multiplexers to the plurality of first optical interfaces.

16. The optical apparatus of claim 15 wherein the singular wavelength-switching device comprises a shared optical assembly,
wherein the shared optical assembly comprises at least one selected from the group consisting of a shared optical lens, a shared diffraction grating, and a shared singular polarization modulation array, and combinations thereof,
wherein the shared singular polarization modulation array comprises one selected from the group consisting of a liquid crystal cell array, a single liquid crystal on silicon (LOCS) chip, and a thin-film transistor liquid crystal panel, and to the plurality of first optical interfaces,
wherein the liquid crystal cell array comprises a plurality of pixel cells, wherein at least one of the plurality of pixel cells is operable to rotate or not rotate the polarization orientation of light incident thereon to switch at least one wavelength of the plurality of first wavelengths within the singular wavelength-switching device.

17. The optical apparatus of claim 16, further comprising an amplified spontaneous emission (ASE) noise source operable to generate ASE noise, wherein the singular wavelength-switching device is operable to selectively substitute at least one wavelength of the plurality of first wavelengths with the ASE noise from the ASE noise source.

18. The optical apparatus of claim 16, further comprising:
a plurality of second optical interfaces; and
a plurality of optical wavelength demultiplexers operable to demultiplex a plurality of second wavelengths to the plurality of optical transceivers,
wherein the singular wavelength-switching device is operable to individually switch wavelengths of the plurality of second wavelengths from the plurality of second optical interfaces to the plurality of optical wavelength demultiplexers.

19. The optical apparatus of claim 18, wherein the singular wavelength-switching device comprises a plurality of M×N wavelength selective switches,
wherein each M×N wavelength selective switch comprises M input ports and N output ports,
wherein the plurality of M×N wavelength selective switches are operable to switch one or more wavelengths of the plurality of first wavelengths from the plurality of optical wavelength multiplexers to the plurality of first optical interfaces and to the plurality of optical wavelength demultiplexers, and
wherein the plurality of M×N wavelength selective switches are operable to switch one or more wavelengths of the plurality of second wavelengths from the plurality of second optical interfaces to the plurality of optical wavelength demultiplexers and to the plurality of first optical interfaces.

20. The optical apparatus of claim 19, further comprising an amplified spontaneous emission (ASE) noise source operable to generate ASE noise, wherein the plurality of M×N wavelength selective switches are operable to selectively substitute wavelengths of the plurality of first wavelengths with the ASE noise from the ASE noise source.
